(19) United States
(12) Patent Application Publication
(10) Pub. No.: US 2016/0071373 A1
(43) Pub. Date: Mar. 10, 2016

(54) CONTROLLING MOBILE GAMING

(71) Applicant: WMS Gaming, Inc., Waukegan, IL (US)

(72) Inventors: Peter R. Anderson, Glenview, IL (US); Mark B. Gagner, West Chicago, IL (US); Anuradha Jandhyala, Chicago, IL (US); Sean P. Kelly, Skokie, IL (US); Vladislav Modilevsky, Buffalo Grove, IL (US); Justin A. Perkins, Chicago, IL (US); Jorge L. Shimabukuro, Las Vegas, NV (US); Nickey C. Shin, Chicago, IL (US); Craig J. Sylla, Round Lake, IL (US); Matthew J. Ward, Northbrook, IL (US)

(21) Appl. No.: 14/852,231

(22) Filed: Sep. 11, 2015

Related U.S. Application Data
(63) Continuation-in-part of application No. 14/499,048, filed on Sep. 26, 2014.
Application No. 14/499,048 is a continuation-in-part of application No. 14/260,025, filed on Apr. 23, 2014.
(60) Provisional application No. 61/815,601, filed on Apr. 24, 2013.

(51) Int. Cl. G07F 17/32

(52) U.S. Cl. CPC G07F 17/3246; G07F 17/3239; G07F 17/322; G07F 17/3218; G07F 17/3223; G07F 17/3288

(57) ABSTRACT

A method and system to perform operations for providing mobile gaming. In some instances, the operations include detecting a cash input at a casino kiosk, generating an electronic tracking identifier, and storing a first copy of the electronic tracking identifier in a memory accessible to a gaming server. The operations can further include causing a casino accounting system to generate a casino accounting system identifier associated with an amount for the cash input. The operations can further include obtaining the casino accounting system identifier, associating the casino accounting system identifier with the first copy of the electronic tracking identifier; and instructing the casino kiosk to present a second copy of the electronic tracking identifier to link to a mobile device for the mobile gaming session.

### RELATED APPLICATIONS

This application claims priority benefit of, and is a continuation-in-part of, U.S. application Ser. No. 14/499,048 filed Sep. 26, 2014, which is a continuation-in-part application that claims priority benefit of U.S. application Ser. No. 14/260,025 filed Apr. 23, 2014, which claims the priority benefit of U.S. Provisional Application No. 61/815,601 filed Apr. 24, 2013. The 14/499,048 Application, the 14/260,025 Application and the 61/815,601 Application are each incorporated by reference herein in their respective entireties.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2015, WMS Gaming, Inc.

### FIELD

Embodiments of the inventive subject matter relate generally to wagering game systems, and more particularly to mobile wagering game systems.

### BACKGROUND

Cashless wagering game systems have become commonplace in casinos. Instead of currency, cashless wagering game systems utilize cash substitutes, such as tickets, player identification cards, credit cards, etc. for transactions taking place during wagering gameplay. For example, when a player cashes out at the end of a wagering game session, the wagering game machine prints a ticket representing the credit meter's cash value at the time of cash out. The player can then take the ticket and insert it in another wagering game machine and begin gameplay. Additionally, the player can exchange the ticket for cash at a cashier or kiosk. Although cashless wagering game systems have many advantages, tickets can be easily lost, misplaced, stolen, etc. before the player is able to redeem them.

### BRIEF DESCRIPTION OF THE FIGURES

Embodiments of the invention are illustrated in the Figures of the accompanying drawings in which:

FIG. 1A depicts a wagering game ticket 102, according to some embodiments of the inventive subject matter.

FIG. 1B depicts a mobile device 116 capturing an image of a wagering game ticket 112.

FIG. 2 is a flow diagram illustrating example operations for depositing a wagering game ticket using a mobile device, according to some embodiments of the inventive subject matter.

FIG. 3 is flow diagram illustrating example operations for depositing a wagering game ticket in a player account, according to some embodiments of the inventive subject matter.

FIG. 4 is a flow diagram illustrating example operations for depositing a wagering game ticket using a mobile device, according to some embodiments of the inventive subject matter.

FIG. 5 is flow diagram illustrating example operations for depositing a wagering game ticket in a player account, according to some embodiments of the inventive subject matter.

FIG. 6 is a flow diagram illustrating example operations for transferring funds from a player account to a wagering game ticket using a mobile device, according to some embodiments of the inventive subject matter.

FIG. 7 is a flow diagram illustrating example operations for transferring funds from a player account to a wagering game ticket, according to some embodiments of the inventive subject matter.

FIG. 8 is a flow diagram illustrating example operations for transferring funds from a player account to a wagering game ticket, according to some embodiments of the inventive subject matter.

FIG. 9 is a flow diagram illustrating example operations for purchasing tangible gaming instruments with funds in a player account using a mobile device, according to some embodiments of the inventive subject matter.

FIG. 10 is a flow diagram illustrating example operations for purchasing tangible gaming instruments with funds in a player account, according to some embodiments of the inventive subject matter.

FIG. 11 is a flow diagram illustrating example operations for purchasing tangible gaming instruments with funds in a player account, according to some embodiments of the inventive subject matter.

FIG. 12 is a block diagram illustrating a wagering game network 600, according to example embodiments of the invention.

FIG. 13 is a block diagram illustrating a wagering game machine architecture, according to example embodiments of the invention.

FIG. 14 is a perspective view of a wagering game machine, according to example embodiments of the invention.

FIG. 15A depicts a system for creating an e-ticket for storage on a mobile device 1504.

FIG. 15B depicts a system for redeeming an e-ticket stored on a mobile device 1514 using a scanning system 1512.

FIG. 16 is a flow diagram depicting example operations for creating an e-ticket for storage on a mobile device and redeeming the e-ticket, according to example embodiments of the invention.

FIG. 17 is a flow diagram depicting example operations for creating an e-ticket for storage on a mobile device, according to example embodiments of the invention.

FIG. 18 is a flow diagram depicting example operations for redeeming an e-ticket stored on a mobile device using a scanning system, according to example embodiments of the invention.

FIG. 19 is a flow diagram 1900 illustrating mobile electronic gaming according to some embodiments.

FIG. 20 illustrates some embodiments associated with the flow diagram 1900 pertaining to monetary input for a gaming session.

FIG. 21 illustrates some embodiments associated with the flow diagram 1900 pertaining to generating a tracking identifier.

FIG. 22 illustrates some embodiments associated with the flow diagram 1900 pertaining to communication with a ticketing system and associating a tracking identifier with a ticketing system identifier.

FIG. 23 illustrates some embodiments associated with the flow diagram 1900 pertaining to associating a mobile device identifier with a tracking identifier.

FIG. 24 illustrates some embodiments associated with the flow diagram 1900 pertaining to associating a mobile device identifier with a tracking identifier.

FIG. 25 illustrates some embodiments associated with the flow diagram 1900 pertaining to associating a mobile device identifier with a tracking identifier.

FIG. 26 illustrates some embodiments associated with the flow diagram 1900 pertaining to funding a gaming session using a tracking identifier and a ticketing system identifier.

FIG. 27 illustrates some embodiments associated with the flow diagram 1900 pertaining to funding a gaming session.

FIG. 28 illustrates some embodiments associated with the flow diagram 1900 pertaining to using, during a gaming session, funds associated with a tracking identifier.

FIG. 29 illustrates some embodiments associated with the flow diagram 1900 pertaining to game play, during a gaming session, with funds associated with a tracking identifier.

FIG. 30 illustrates some embodiments associated with the flow diagram 1900 pertaining to game play, during a gaming session, with funds associated with a tracking identifier.

FIG. 31 illustrates some embodiments associated with the flow diagram 1900 pertaining to initiating a cash out procedure via a mobile device.

FIG. 32 illustrates some embodiments associated with the flow diagram 1900 pertaining to presenting a cash out voucher via a mobile device for presentation at a kiosk.

FIG. 33 illustrates some embodiments associated with the flow diagram 1900 pertaining to a cash out procedure using a tracking identifier.

FIG. 34 illustrates some embodiments associated with the flow diagram 1900 pertaining to communication with a ticketing system and associating a tracking identifier with a ticketing system identifier.

FIG. 35 illustrates some embodiments associated with the flow diagram 1900 pertaining to associating a ticketing system identifier with a database.

FIG. 36 illustrates some embodiments associated with the flow diagram 1900 pertaining to adding funds to a mobile gaming session.

FIG. 37 illustrates some embodiments associated with the flow diagram 1900 pertaining to printing tickets for association with a mobile device identifier.

FIG. 38 illustrates some embodiments associated with the flow diagram 1900 pertaining to adding funds to a tracking identifier.

### DESCRIPTION OF THE EMBODIMENTS

This description of the embodiments is divided into four sections. The first section provides an introduction to embodiments of the invention, while the second section describes example operations performed by some embodiments. The third section discusses wagering game networks, while the fourth section describes wagering game machines.

### Introduction

This section provides an introduction to some embodiments of the invention.

Some embodiments of the inventive subject matter allow a player to deposit a wagering game ticket using a mobile device. For example, in some embodiments, a wagering game machine prints a wagering game ticket representing the player's credit meter balance at cash out. The wagering game ticket can include a unique identifier, such as a two-dimensional (2D) barcode, that indicates the player's player account, monetary value associated with the ticket, and other information. The player can then take a picture of the wagering game ticket with a mobile device, such a cellular telephone. The mobile device can then transmit the information contained on the wagering game ticket to a player account server. The player account server can then communicate with a ticketing server, which determines the monetary balance associated with the wagering game ticket. The player account server can then deposit the wagering game ticket (i.e., the monetary value associated with the wagering game ticket) in the player's player account.

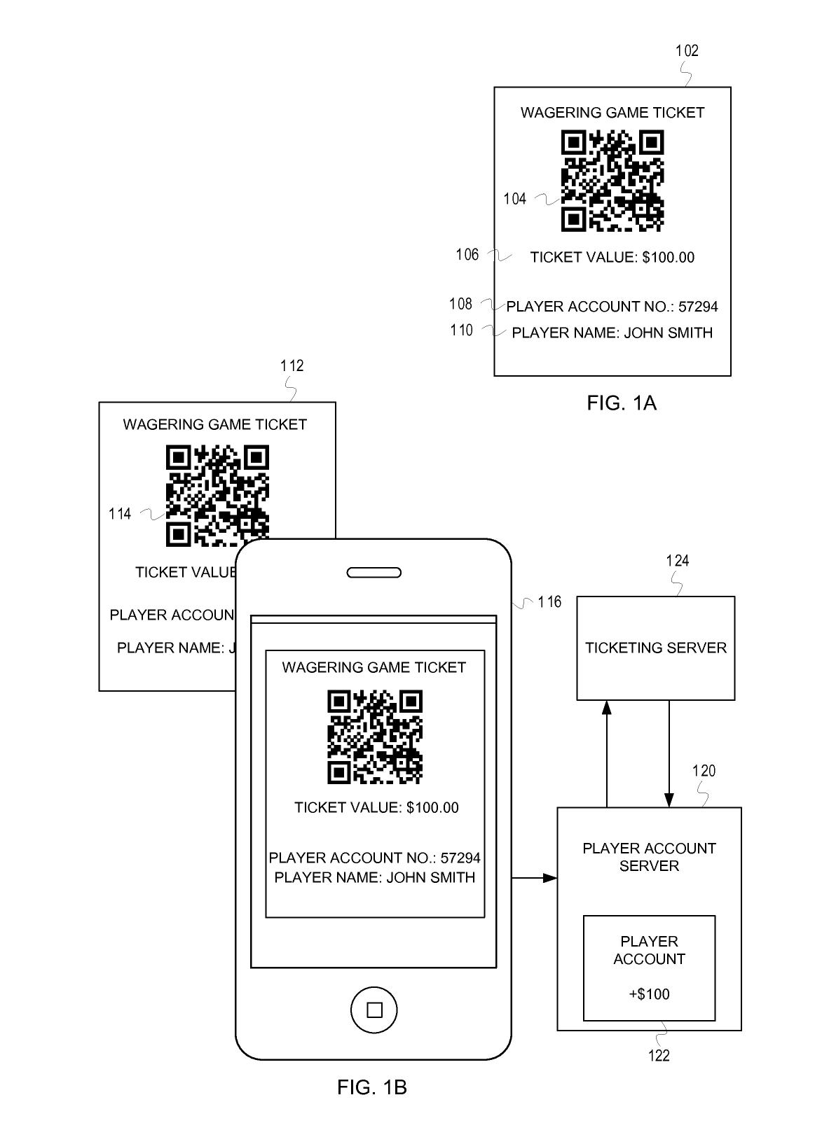

FIG. 1A depicts a wagering game ticket 102, according to some embodiments of the inventive subject matter. As depicted in FIG. 1A, the wagering game ticket 102 contains a unique identifier 104, an indication of the wagering game ticket value 106, the name of the player 110 that owns the player account associated with the wagering game ticket, and the player's player account number 108. In some embodiments, the wagering game ticket 102 can contain more or less information than is depicted in FIG. 1A. For example, the wagering game ticket 102 can contain only the unique identifier 104. In some embodiments, the wagering game ticket value, player tracking information, etc. can be embedded in the unique identifier 104. Additionally, the unique identifier 104 can take any suitable form, such as a one-dimensional (1D) barcode, a 2D barcode, a unique alphabetic code, a unique numeric code, a unique alphanumeric code, etc.

FIG. 1B depicts a mobile device 116 capturing an image of a wagering game ticket 112. After capturing the image, the mobile device 116 can transmit the image or information taken from the image to the player account server 120. The player account server 120 communicates with a ticketing server 124 to verify the monetary value associated with the wagering game ticket 112. The player account server 120 deposits the money into the player account 122.

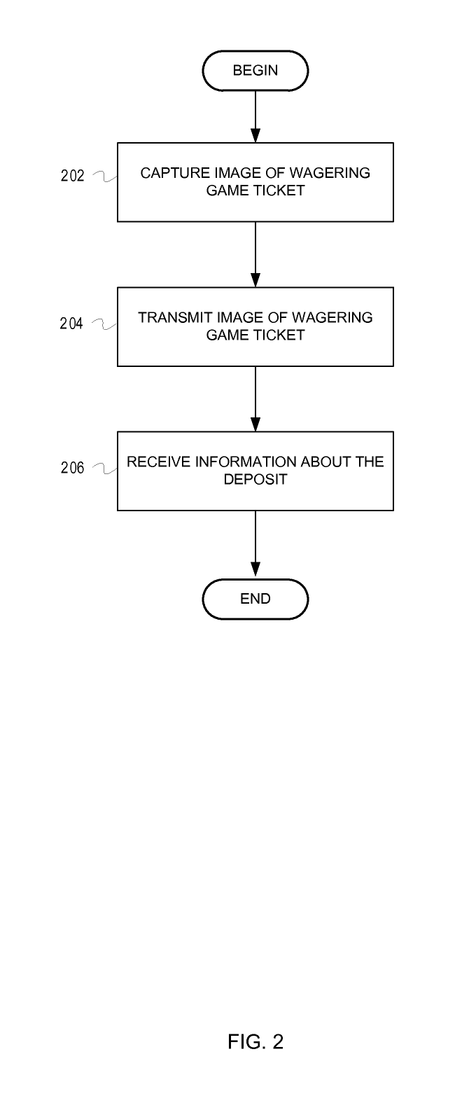

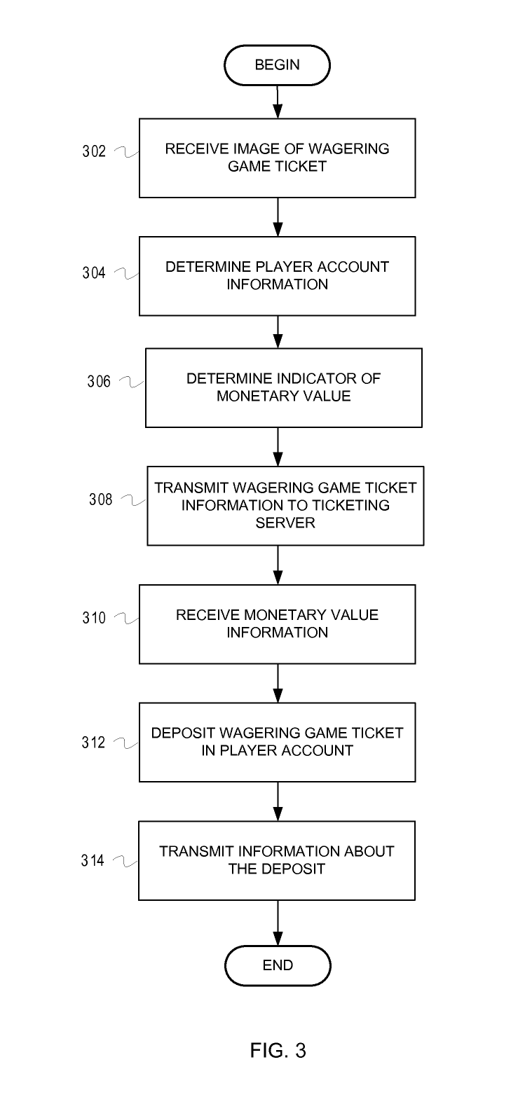

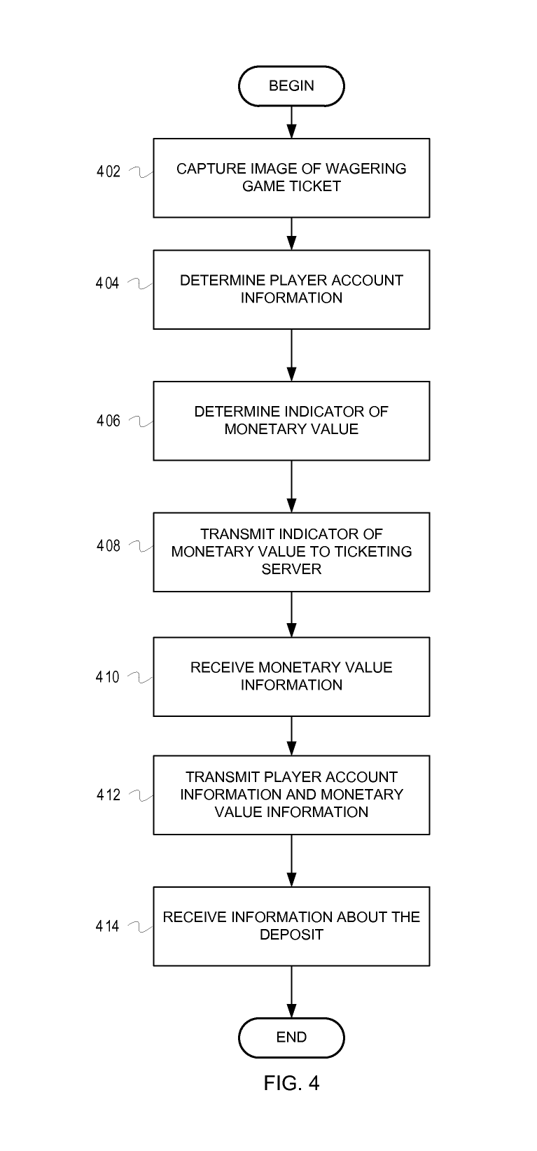

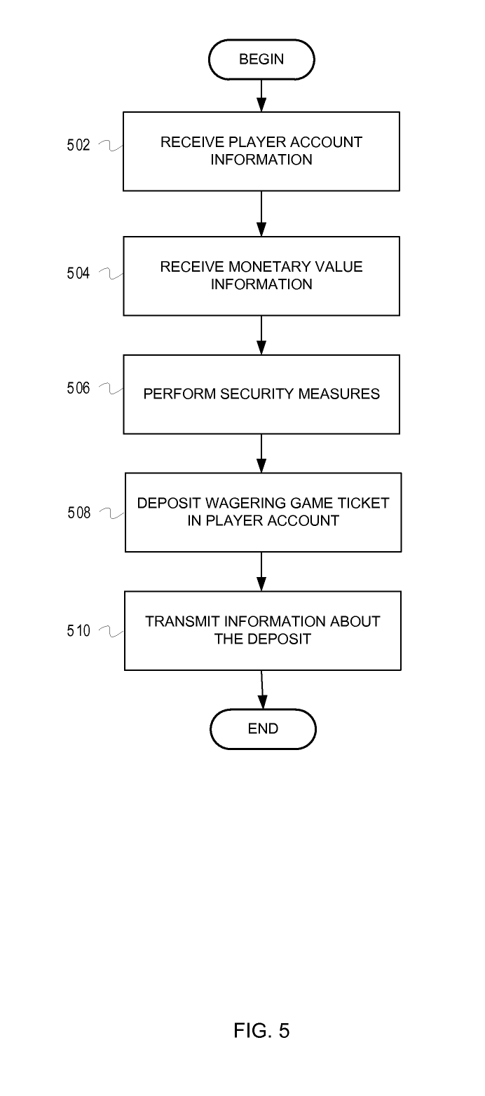

As noted above, some embodiments of the mobile device 116 send the image of the wagering game ticket 112 to the player account server 120, so the player account server processes the image (see discussion of FIGS. 2 and 3). In other embodiments, the mobile device 116 itself processes the image, and then sends the pertinent information (i.e., monetary value associated with the ticket, player account number, etc.) to the player account server 120 (see discussion of FIGS. 4 and 5).

In one embodiment of the inventive subject matter, the player makes the deposit through a web browser based system. For example, the player navigates the web browser on their mobile device to a webpage associated with the player account server. Once at the webpage, the player uploads the image of the wagering game ticket (or information associated with the wagering game ticket) to the player account server. In another embodiment, the player makes the deposit through a dedicated application running on the mobile device. For example, the application can be associated with the player account server. The player can open the application, and through the application, upload the image of the wagering game ticket (or information associated with the wagering game ticket) to the player account server.

Although FIG. 1 describes some embodiments, the following sections describe many other features and embodiments.

### Example Operations

This section describes operations associated with some embodiments of the invention. In the discussion below, the flow diagrams will be described with reference to the diagrams presented above. However, in some embodiments, the operations can be performed by logic not described in the diagrams.

In certain embodiments, the operations can be performed by executing instructions residing on machine-readable media (e.g., software), while in other embodiments, the operations can be performed by hardware and/or other logic (e.g., firmware). In some embodiments, the operations can be performed in series, while in other embodiments, one or more of the operations can be performed in parallel. Moreover, some embodiments can perform less than all the operations shown in any flow diagram.

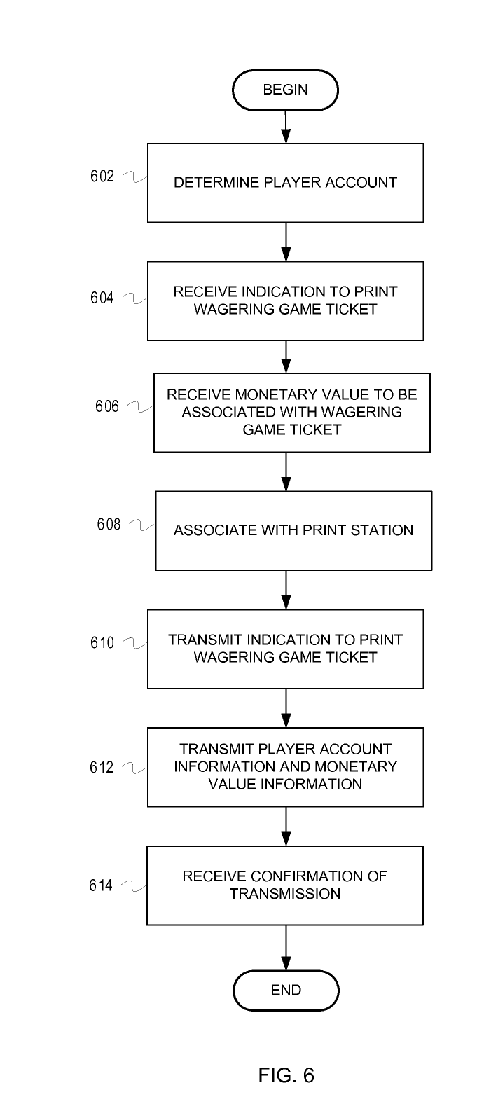

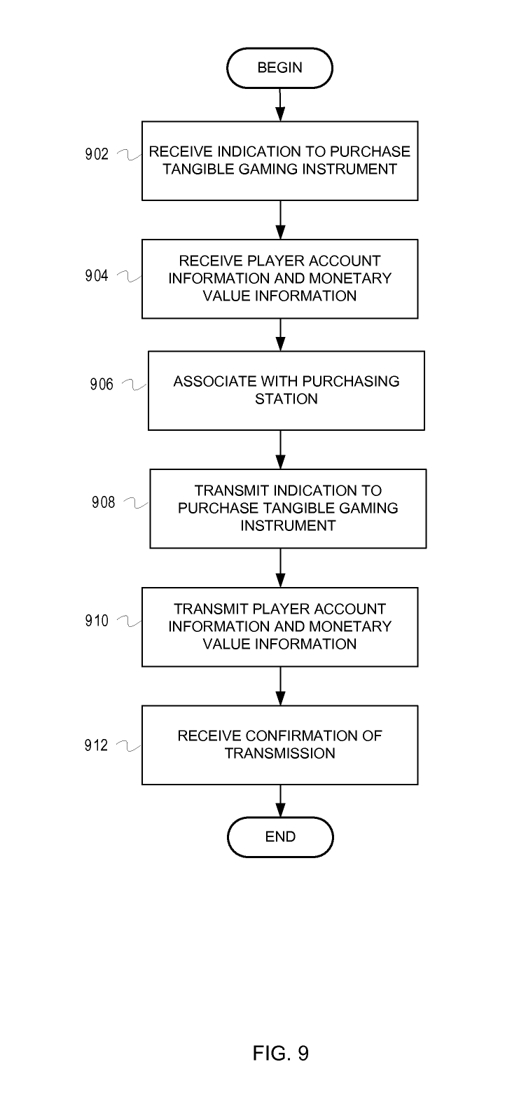

The section will discuss FIGS. 2-11. The discussion of FIGS. 2-5 will describe operations for processing an image of wagering game ticket and depositing the monetary value associated with the wagering game ticket in a player account. The discussion of FIGS. 6-8 will describe operations for transferring funds from a player account to a wagering game ticket. The discussion of FIGS. 9-11 will describe operations for purchasing tangible gaming instruments with funds in a player account.

FIG. 2 is a flow diagram illustrating example operations for depositing a wagering game ticket using a mobile device, according to some embodiments of the inventive subject matter. The flow begins at block 202.

At block 202, the mobile device captures an image of the wagering game ticket. In some embodiments, the player takes a picture of the wagering game ticket, and the image of the wagering game ticket is stored on the mobile device. In other embodiments, the player “scans” the wagering game ticket. In such embodiments, the image of the wagering game ticket is not saved to the mobile device. Rather, when the image appears in the mobile device's view finder, the mobile device temporarily stores image information in a camera buffer. The image is acquired by accessing the mobile device's camera buffer and retrieving the image. Furthermore, in some embodiments, it is unnecessary for the player to capture an image of the entire wagering game ticket. In such embodiments, it is only necessary for the player to capture an image of the unique identifier on the wagering game ticket. The flow continues at block 204.

At block 204, the mobile device transmits an image of the wagering game ticket to the player account server. The mobile device may transmit the image information via a wireless telephone network, a local area wireless network, or any other suitable communications network. In some embodiments, the mobile device may transmit an image of the entire wagering game ticket. In other embodiments, the mobile device may crop the image of the wagering game ticket, so that the cropped image contains only the necessary information, such as the unique identifier, player account associated with the wagering game ticket, the monetary value associated with the wagering game ticket, etc. It should also be noted that in some embodiments, the mobile device transmits the image of the wagering game ticket to a wagering game server. In such embodiments, the wagering game server communicates with the player account server to facilitate deposit of the wagering game ticket. The flow continues at block 206.

At block 206, the mobile device receives information about the deposit. For example, the mobile device can receive a confirmation that the deposit was successful.

While FIG. 2 describes embodiments in which the mobile device transmits the image of the wagering game ticket to the player account server for processing from the perspective of the mobile device, FIG. 3 describes these same embodiments from the perspective of the player account server.

FIG. 3 is flow diagram illustrating example operations for depositing a wagering game ticket in a player account, according to some embodiments of the inventive subject matter. The flow begins at block 302.

At block 302, the player account server receives the image of the wagering game ticket. In some embodiments, the player account server receives an image of the entire wagering game ticket. In other embodiments, the player account server receives an image of just some of the information on the wagering game ticket. For example, the player account server may receive only an image of the unique identifier. The flow continues at block 304.

At block 304, the player account server determines the player account information (the player account associated with the wagering game ticket). In some embodiments, the player account server determines the player account associated with the wagering game ticket from information contained on the wagering game ticket. For example, the player account server can employ optical character recognition (OCR) or other computer vision techniques to determine the name of the player or the player's player account number printed on the wagering game ticket. Additionally, the player's name or player account can be embedded in the unique identifier. In such embodiments, the player account server determines the player account associated with the wagering game ticket by scanning or processing the unique identifier. In other embodiments, a player account may not be associated with the wagering game ticket (i.e., the ticket is not issued to a particular player account). In such embodiments, the player account server can determine the player account into which the deposit should be made through other means. For example, the player may have to login to a webpage or application from the mobile device to initiate the deposit. The player account server can determine the player account into which the deposit should be made based on this login information. The flow continues at block 306.

At block 306, the player account server determines an indicator of the monetary value. In some embodiments, the unique identifier printed on the wagering game ticket contains the monetary value information. The flow continues at block 308.

At block 308, the player account server transmits the wagering game ticket information to a ticketing server. The wagering game ticket information can include an indication of the monetary value associated with the wagering game ticket, a wagering game ticket serial number, etc. In some embodiments, the ticketing server resides on the same hardware on which the player account server resides. In other embodiments, the ticketing server resides on standalone hardware. In some embodiments, the ticketing server is associated with a different business entity (e.g., company) than the entity associated with the player account server or the wagering game machine that printed the wagering game ticket. For example, a wagering game ticket may be printed from a wagering game machine associated with WMS Gaming, Inc. of Chicago, Ill., and the ticketing server may be associated with International Game Technologies (IGT) of Reno, Nev., using Ticket In/Ticket Out (TITO) technology to determine the monetary value associated with the wagering game ticket. The flow continues at block 310.

At block 310, the player account server receives the monetary value information from the ticketing server. In other words, the player account server receives an indication of the monetary value associated with the wagering game ticket. The flow continues at block 312.

At block 312, the player account server deposits the wagering game ticket in the player account. Additionally, in some embodiments, once the wagering game ticket has been deposited, the wagering game ticket can be voided, or recorded as deposited in a database to prevent the wagering game ticket from being deposited a second time. The flow continues at block 314.

At block 314, the player account server transmits information about the deposit. For example, the player account server can transmit a confirmation that the deposit was successful. Additionally, the wagering game server can transmit an indication of the current balance in the player account.

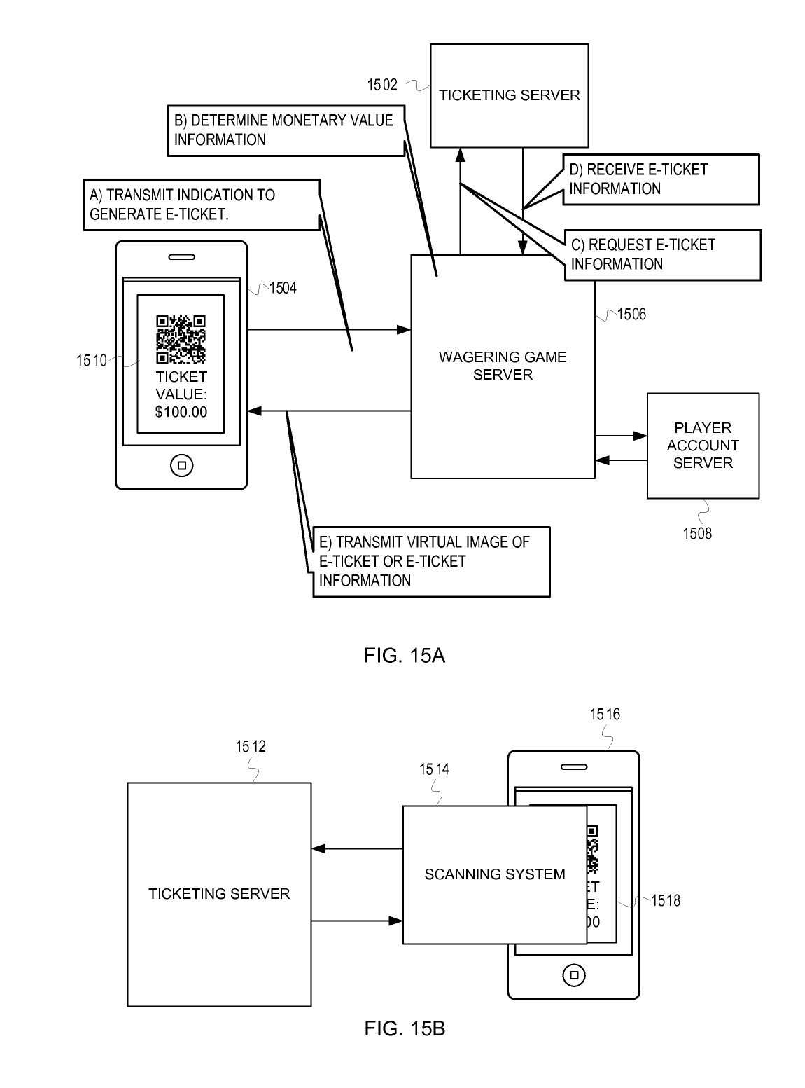

Although the discussion of FIGS. 2 and 3 describes depositing a wagering game ticket in a specific player account, embodiments are not so limited. For example, a player may not have a player account or may not want a wagering game ticket deposited in his/her player account. In such embodiments, the wagering game server can perform functions similar to those of the player account server. For example, the wagering game server creates a temporary account for the player. The wagering game server creates the temporary account when the player begins a wagering game session (or deposits the wagering game ticket) and exists for the duration of the wagering game session. Although the temporary account is not linked to the player, the wagering game server links the temporary account to the mobile device or a wagering game machine. For example, the wagering game server can link the temporary account to a unique identifier of the mobile device (e.g., a MAC address, and IP address, etc.) or a unique identifier of the wagering game machine. When the mobile device transmits the image of the wagering game ticket, the wagering game server deposits the wagering game ticket in the temporary account. The wagering game server updates a balance of the temporary account as the player plays wagering games during the wagering game session. When the player terminates the wagering game session (e.g., cashes out), the temporary account is closed and the balance of the temporary account is removed (e.g., by creating a new wagering game ticket). As described in more detail in the discussion of FIGS. 15-17, an e-ticket can be created when the player cashes out.

In FIGS. 2 and 3, as part of the process for depositing a ticket into a player account, the player account server processes the ticket image. However, in some embodiments, the mobile phone can process the image (e.g., by applying OCR to determine the ticket value, etc.). FIGS. 3 and 4 describe operations for depositing a ticket into a player account, where the mobile phone processes the image.

FIG. 4 is a flow diagram illustrating example operations for depositing a wagering game ticket using a mobile device, according to some embodiments of the inventive subject matter. The flow begins at block 402.

At block 402, the mobile device captures an image of the wagering game ticket. In some embodiments, a player takes a picture of the wagering game ticket, and the image of the wagering game ticket is stored on the mobile device. In other embodiments, the player “scans” the wagering game ticket. In such embodiments, the image of the wagering game ticket is not saved to the mobile device. Rather, the image is acquired by accessing the mobile device's camera buffer and retrieving the image. As a player points the camera at a ticket, the image appears in the mobile device's view finder. Images in the camera's viewfinder are temporarily represented in a camera buffer of the mobile phone. Embodiments can access images in the camera buffer even though a picture has not been taken. In some embodiments, it is unnecessary for the player to capture an image of the entire wagering game ticket. In such embodiments, it is only necessary for the player to capture an image of the unique identifier on the wagering game ticket. The flow continues at block 404.

At block 404, the mobile device determines the player account information (the player account associated with the wagering game ticket). In some embodiments, the mobile device determines the player account associated with the wagering game ticket from information contained on the wagering game ticket. For example, the mobile device can employ OCR or other computer vision techniques to determine the player's name or the player's player account number printed on the wagering game ticket. Additionally, the player's name or player account can be embedded in the unique identifier. In such embodiments, the mobile device determines the player account associated with the wagering game ticket by scanning or processing the unique identifier. In other embodiments, a player account may not be associated with the wagering game ticket (i.e., the ticket is not issued to a particular player account). In such embodiments, the mobile device can determine the player account into which the deposit should be made through other means. For example, the player may have to login to a webpage or application from the mobile device to initiate the deposit. The mobile device can determine the player account into which the deposit should be made based on this login information. The flow continues at block 406.

At block 406, the mobile device determines the indicator of the monetary value. In some embodiments, the unique identifier printed on the wagering game ticket contains the monetary value information. The flow continues at block 408.

At block 408, the mobile device transmits the indicator of the monetary value to a ticketing server. The ticketing server, using the indicator of the monetary value, determines the monetary value associated with the wagering game ticket (the monetary value information). The flow continues at block 410.

At block 410, the mobile device receives the monetary value information from the ticketing server. In other words, the mobile device receives an indication of the monetary value associated with the wagering game ticket. The flow continues at block 412.

At block 412, the mobile device transmits the player account information and the monetary value information to the player account server. This transmission may be achieved by any suitable means, both wired and wireless. For example, the mobile device can communicate with the player account server via a cellular telephone network, Wi-Fi network, etc. Additionally, in some embodiments, the mobile device may also transmit an image of the wagering game ticket (or unique identifier) to the player account server. In such embodiments, the player account server can maintain images of the deposited wagering game tickets, log transaction information pertaining to the wagering game tickets, etc. The flow continues at block 414.

At block 414, the mobile device receives information about the deposit from the player account server. For example, the mobile device can receive a confirmation that the deposit was successful.

While FIG. 4 describes embodiments where the mobile device processes the image of the wagering game ticket and sends the relevant information to the player account server, FIG. 5 describes complimentary operations performed by embodiments of the player account server.

FIG. 5 is flow diagram illustrating example operations for depositing a wagering game ticket in a player account, according to some embodiments of the inventive subject matter. The flow begins at block 502.

At block 502, the player account server receives player account information. The player account server can receive this information via any suitable wired or wireless means. The flow continues at block 504.

At block 504, the player account server receives the monetary value information. The player account server can receive this information via any suitable wired or wireless means. The flow continues at block 506.

At block 506, the player account server performs security measures. In some embodiments, the player account server can verify the information received in a database. For example, the player account server can search a database of all issued wagering game tickets. The database can contain information about each issued wagering game ticket, such as the player account to which the wagering game ticket was issued, the monetary value associated with the wagering game ticket, whether the wagering game ticket has been previously deposited, etc. In some embodiments, a portion of this information may reside on the ticketing server. For example, the monetary value associated with the wagering game ticket, a wagering game ticket serial number, etc. may reside on the ticketing server. In such embodiments, the player account server can interact with the ticketing server to perform security measures. Upon searching the database and/or interacting with the ticketing server, if the player account server determines that the ticket is fraudulent, has already been deposited, etc., the player account server can refuse to make the deposit. In some embodiments, the player account server can relay the monetary value information received from the mobile device to the ticketing server for verification. The flow continues at block 508.

At block 508, the player account server deposits the wagering game ticket in the player account. As previously discussed, if the player account server determines that the wagering game ticket is fraudulent or otherwise invalid, the player account server can refuse to make the deposit. Additionally, in some embodiments, once the wagering game ticket has been deposited, the wagering game ticket can be voided, or recorded in the database as deposited to prevent the wagering game ticket form being deposited a second time. The flow continues at block 510.

At block 510, the player account server transmits information about the deposit. For example, the player account server can transmit a confirmation that the deposit was successful. Additionally, the player account server can transmit an indication of the current balance in the player account.

While FIGS. 2-5 describe operations for processing an image of wagering game ticket and depositing the monetary value associated with the wagering game ticket in a player account, FIGS. 6-8 describe operations for transferring funds from a player account to a wagering game ticket. In some embodiments, transferring funds from a player account to a wagering game ticket requires action by three components: a mobile device, a print station, and a player account server. In broad terms, the mobile device communicates with the print server, indicating a desire to print a wagering game ticket. The print server communicates with the player account server to facilitate that transfer of funds from the player account. The player account server withdraws the funds from the player account to be associated with the wagering game ticket. Finally, after all relevant information is received from the mobile device and the player account server, the print station prints the wagering game ticket.

FIG. 6 is a flow diagram illustrating operations for transferring funds from a player account to a wagering game ticket using a mobile device, according to some embodiments of the inventive subject matter. The flow begins at block 602.

At block 602, the mobile device determines a player account from which to transfer funds. In some embodiments, the player is required to login to a webpage or application on the mobile device to transfer funds from their player account to a wagering game ticket. In such embodiments, the mobile device can determine the player account based on the login credentials. The flow continues at block 604.

At block 604, the mobile device receives an indication to print (e.g., on a nearby print station) a wagering game ticket representing funds transferred from the player account to the wagering game ticket. In some embodiments, the player can indicate a desire to print a wagering game ticket via a website associated with the player account server or using an application associated with the player account server. The flow continues at block 606.

At block 606, the mobile device receives an indication of the monetary value to be associated with the wagering game ticket. In some embodiments, the player can indicate the amount to be transferred from their player account to the wagering game ticket via a website associated with the player account server or using an application associated with the player account server. The flow continues at block 608.

At block 608, the mobile device associates with a print station which will print the wagering game ticket. In some embodiments, this association is necessary in order ensure that the wagering game ticket will be printed at the correct print station and to prevent fraud. The mobile device can associate with the print station using any suitable means. In some embodiments, the print station may communicate with the mobile device wirelessly, for example, over a near field communications (NFC) network. For example, the print station may request that the mobile device emit an encoded audio signal to verify the mobile device's proximity with the print station. Alternatively, the print station may have a unique identifier associated with it that must be entered on the mobile device to associate with the print station. For example, the print station may have a barcode that the mobile device must scan, or may have a unique code printed on it that must be entered on the mobile device. In some embodiments, the mobile device prompts the player to associate with the print station. In other embodiments, the association may happen automatically. The flow continues at block 610.

At block 610, the mobile device transmits an indication to print the wagering game ticket to the print station. This transmission may be achieved by any suitable means, both wired and wireless. The flow continues at block 612.

At block 612, the mobile device transmits the player account information and the monetary value information to the print station. This transmission may be achieved by any suitable means, both wired and wireless. The flow continues at block 614.

At block 614, the mobile device receives confirmation of the transmission. In some embodiments, the mobile device receives confirmation from the print station that the transmission of the indication to print the wagering game ticket and the transmission of the player account information and monetary value information was successful. In some embodiments, the mobile device receives this confirmation after the transmissions have been made to the print station. In other embodiments, the mobile device receives this confirmation after the transmissions have been passed from the print station to a player account server which processes the transaction. For example, the print station can confirm that the transmissions were successfully passed to the player account server.

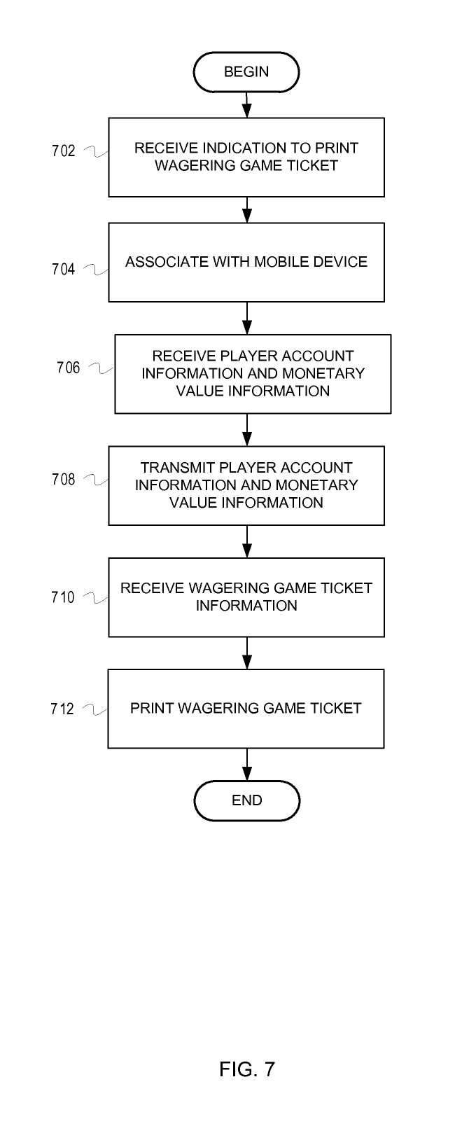

While FIG. 6 describes transferring funds from a player account to a wagering game ticket from the perspective of the mobile device, FIG. 7 describes transferring funds from a player account to a wagering game ticket from the perspective of the print server.

FIG. 7 is a flow diagram illustrating example operations for transferring funds from a player account to a wagering game ticket, according to some embodiments of the inventive subject matter. The flow begins at block 702.

At block 702, the print station receives an indication to print a wagering game ticket. In some embodiments, this indication is received from the mobile device. The flow continues at block 704.

At block 704, the print station associates with the mobile device. The print station can associate with the mobile device via any suitable means, and can either associate automatically or prompt player input for the association. For example, the print station can require player input at the print station or can require player input at the mobile device. In some embodiments, the print station associates with the mobile device wirelessly. In other embodiments, the print station associates with the mobile device when the mobile device is physically connected to the print station. The flow continues at block 706.

At block 706, the print station receives player account information and monetary value information. In some embodiments, the print station receives player account information and monetary value information from the mobile device. In other embodiments, the print station receives the player account information via player input at the print station. The player account information indicates the player account from which funds should be withdrawn. The monetary value information indicates the amount of funds to be withdrawn from the player account and transferred to the wagering game ticket. The flow continues at block 708.

At block 708, the print station transmits the player account information and the monetary value information to the player account server. This transmission can be achieved through any suitable means, both wired and wireless. The flow continues at block 710.

At block 710, the print server receives wagering game ticket information from the player account server. In some embodiments, the wagering game ticket information includes all information necessary to print the wagering game ticket representing the funds transferred from the player account to the wagering game ticket. For example, the wagering game ticket can include an indication of the player account from which the funds were transferred as well as an indication of the monetary value associated with the wagering game ticket. Alternatively, the wagering game ticket may be associated with a player account separate from the player account from which the funds were transferred. For example, Player A may wish to transfer funds from their player account to a wagering game ticket associated with their friend, Player B. The wagering game ticket will then be associated with Player B (i.e., only Player B will be able to access the monetary value associated with the wagering game ticket), but the monetary value associated with the wagering game ticket will have come from funds in Player A's player account. In some embodiments, the wagering game ticket information is only the monetary value associated with the wagering game ticket (i.e., the wagering game ticket is not associated with a specific player). In other embodiments, the wagering game ticket contains more information than the monetary value and the player account. For example, the wagering game ticket can include any type of information, such as a wagering game ticket number, time and date information, etc. The flow continues at block 712.

At block 712, the print station prints the wagering game ticket. In some embodiments, the wagering game ticket is printed with all of the wagering game ticket information received by the print station. In other embodiments, the wagering game ticket is printed with more or less information than is received by the print station.

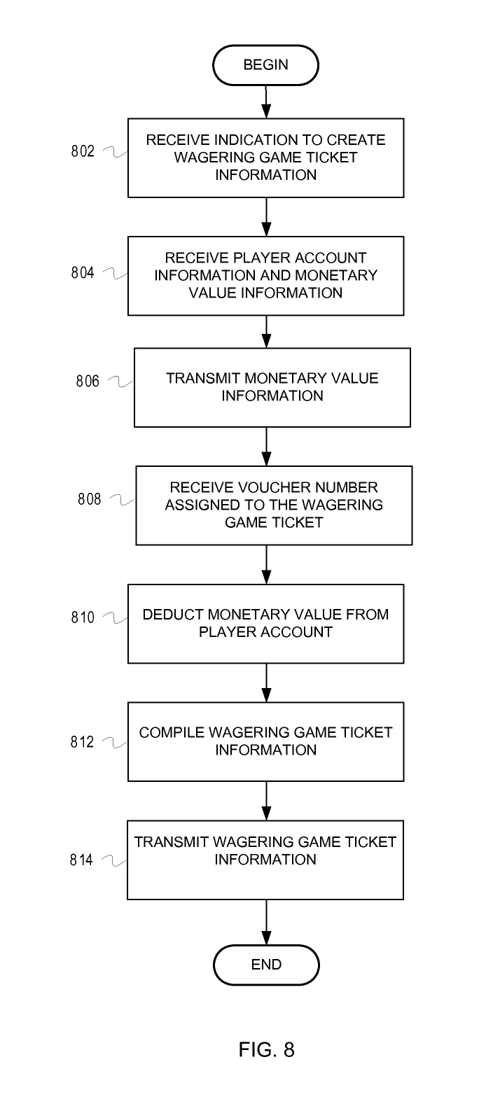

While FIG. 7 describes operations from the perspective of the print server, FIG. 8 describes transferring funds from a player account to a wagering game ticket from the perspective of the player account server.

FIG. 8 is a flow diagram illustrating example operations for transferring funds from a player account to a wagering game ticket, according to some embodiments of the inventive subject matter. The flow begins at block 802.

At block 802, the player account server receives and indication to create wagering game ticket information. In some embodiments, this indication is received from the print station. In other embodiments, this indication is received from the mobile device. The flow continues at block 804.

At block 804, the player account server receives the player account information and the monetary value information. The player account information instructs the player account server to withdraw the monetary value from a specific player account. The monetary value information informs the player account server of the amount of funds to withdraw from the player account and associate with the wagering game ticket. The flow continues at bock 806.

At block 806, the player account server transmits the monetary value information to a ticketing server. The ticketing server assigns a voucher number to the wagering game ticket. The voucher number is associated with the wagering game ticket, and thus reflects the monetary value associated with the wagering game ticket. This voucher number allows the wagering game ticket to be used in a cashless wagering game system. In some embodiments, the ticketing server resides on the same hardware as the player account server. In other embodiments, the ticketing server resides on hardware distinct from that of the player account server. In some embodiments, the player account server and the ticket server are associated with separate or distinct entities. The flow continues at block 808.

At block 808, the player account server receives the voucher number assigned to the wagering game ticket from the ticketing server. This voucher number allows the wagering game ticket to be used in a cashless wagering game system. The flow continues at block 810.

At block 810, the player account server compiles the wagering game ticket information. In some embodiments, the wagering game ticket information includes only the voucher number assigned to the wagering game ticket. In other embodiments, the wagering game information includes more data. For example, the wagering game ticket information can include the player account from which the funds were transferred, a wagering game ticket number, date and time information, etc. The flow continues at block 812.

At block 812, the player account server transmits the wagering game ticket information to the print station, so the print station can print the ticket. This transmission can be achieved by any suitable means, both wired and wireless.

While FIGS. 6-8 describe transferring funds from a player account to a wagering game ticket, FIGS. 9-11 describe using funds in a player account to purchase tangible wagering game instruments, such as chips.

FIG. 9 is a flow diagram illustrating example operations for purchasing tangible gaming instruments with funds in a player account using a mobile device, according to some embodiments of the inventive subject matter. The flow begins at block 902.

At block 902, the mobile device receives an indication to purchase a tangible gaming instrument using funds in a player account. For example, a player may wish to purchase chips for play at a table wagering game such as poker, roulette, etc. The player can use their mobile device to access their player account and use money in their player account to fund the purchase of chips. The flow continues at block 904.

At block 904, the mobile device receives player account information and monetary value information. The player account information allows funds to be withdrawn from the correct player account. The monetary value information indicates the amount of money from the player account to be used to fund the purchase of chips, or other tangible gaming instrument. In some embodiments, the player logs in on the mobile device using a web browser or dedicated application running on the mobile device. In such embodiments, the mobile device can obtain the player account information from the login credentials. In some embodiments, the player enters, on the mobile device, the monetary value they wish to utilize to purchase chips. The flow continues at block 906.

At block 906, the mobile device associates with a purchasing station. In some embodiments, the purchasing station acts as an intermediary between the mobile device and the player account server. Additionally, in some embodiments, the purchasing station can act as a verification mechanism for the casino employee distributing chips or other tangible wagering game instruments. The mobile device can associate with the purchasing station using any suitable means. In some embodiments, the purchasing station may communicate with the mobile device wirelessly, for example, over a near field communications (NFC) network. For example, the purchasing station may request that the mobile device emit an encoded audio signal to verify the mobile device's proximity with the purchasing station. Alternatively, the purchasing station may have a unique identifier associated with it that must be entered on the mobile device to associate with the purchasing station. For example, the purchasing station may have a barcode that the mobile device must scan, or may have a unique code printed on it that must be entered on the mobile device. In some embodiments, the mobile device prompts the player to associate with the purchasing station. In other embodiments, the association may happen automatically. The flow continues at block 908.

At block 908, the mobile device transmits an indication to purchase tangible gaming instruments to the purchasing station. This transmission may be achieved by any suitable means, both wired and wireless. The flow continues at block 910.

At block 910, the mobile device transmits player account information and monetary value information to the purchasing station. The player account information indicates the player account from which to draw funds to purchase the tangible gaming instruments. The monetary value information indicates the value of the tangible gaming instruments to be purchased. This transmission may be achieved by any suitable means, both wired and wireless. The flow continues at block 912.

At block 912, the mobile device receives confirmation of the transmissions. For example, the purchasing station or player account server can communicate with the mobile device indicating that the transmissions were successful.

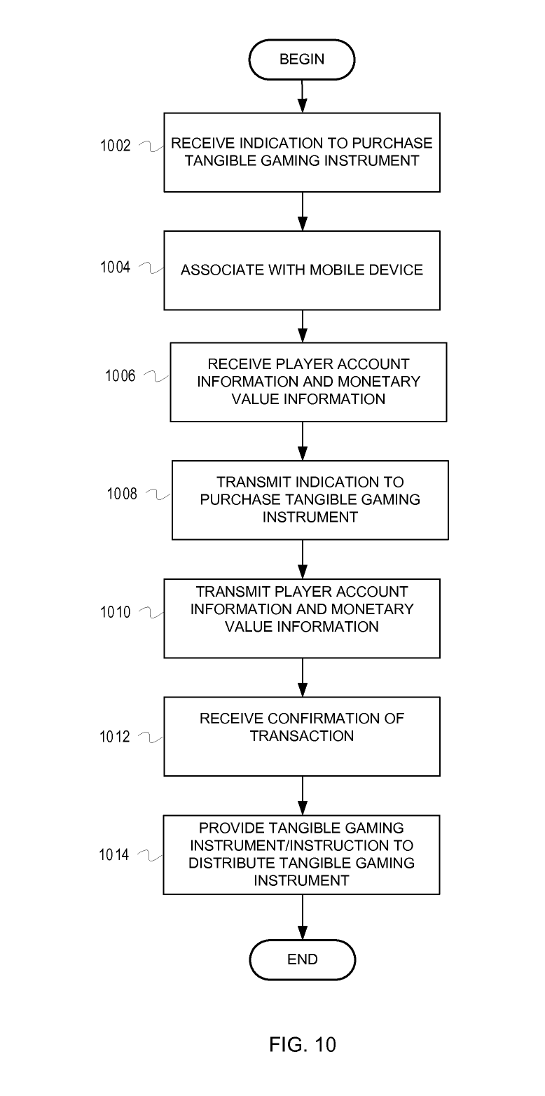

While FIG. 9 describes operations from the perspective of the mobile device, FIG. 10 describes operations for purchasing tangible wagering game instruments from the perspective of the purchasing station.

FIG. 10 is a flow diagram illustrating example operations for purchasing tangible gaming instruments with funds in a player account, according to some embodiments of the inventive subject matter. The flow begins at block 1002.

At block 1002, the purchasing station receives an indication to purchase tangible gaming instruments from the mobile device. This transmission may be achieved by any suitable means, both wired and wireless. The flow continues at block 1004.

At block 1004, the purchasing station associates with the mobile device. The purchasing station can associate with the mobile device via any suitable means, and can either associate automatically or prompt player input for the association. For example, the purchasing station can require player input at the purchasing station or can require player input at the mobile device. In some embodiments, the purchasing station associates with the mobile device wirelessly. In other embodiments, the purchasing station associates with the mobile device when the mobile device is physically connected to the purchasing station. The flow continues at block 1006.

At block 1006, the purchasing station receives player account information and monetary value information from the mobile device. This transmission may be achieved by any suitable means, both wired and wireless. The flow continues at block 1008.

At block 1008, the purchasing station transmits and indication to purchase tangible gaming instruments to the player account server. This transmission may be achieved by any suitable means, both wired and wireless. The flow continues at block 1010.

At block 1010, the purchasing station transmits player account information and monetary value information to the player account server. This transmission may be achieved by any suitable means, both wired and wireless. The flow continues at block 1012.

At block 1012, the purchasing station receives confirmation of the transaction. For example, the purchasing station can receive an indication from the player account server that the player account server has received the transmissions and successfully withdrawn the monetary value from the player account. The flow continues at block 1014.

At block 1014, the purchasing station provides that tangible gaming instruments to the player. However, in some embodiments, the purchasing station may not physically provide the player with the tangible gaming instruments. Rather, the print station provides an instruction to a casino employee to distribute tangible gaming instruments to the player. Additionally, in some embodiments, the purchasing station prints a voucher representing the tangible gaming instruments purchased. The player can then exchange the voucher for tangible gaming instruments.

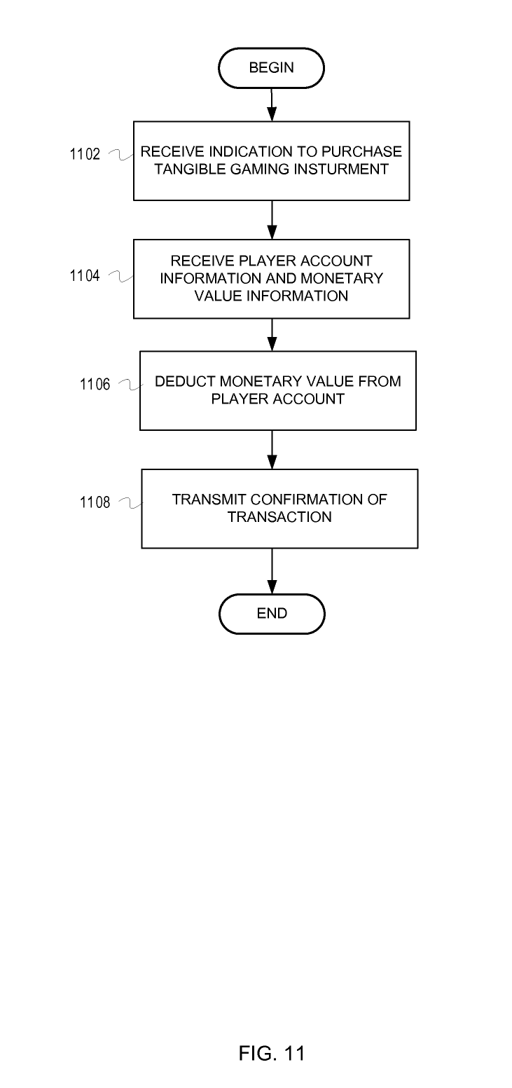

While FIG. 10 describes using funds in a player account to purchase tangible wagering game instruments from the perspective of the purchasing station, FIG. 11 describes using funds in a player account to purchase tangible wagering game instruments from the perspective of the player account server.

FIG. 11 is a flow diagram illustrating example operations for purchasing tangible gaming instruments with funds in a player account, according to some embodiments of the inventive subject matter. The flow begins at block 1102.

At block 1102, the player account server receives the indication to purchase tangible gaming instruments. In some embodiments, the player account server receives the indication from the mobile device. In other embodiments, the player account server receives the indication from the purchasing station. The indication can be sent by any suitable means, both wired and wirelessly. The flow continues at block 1104.

At block 1104, the player account server receives the player account information and monetary value information. The player account information indicates the player account from which the funds to purchase the tangible gaming instruments should be withdrawn. The monetary value information indicates the amount of the funds to be withdrawn. The flow continues at block 1106.

At block 1106, the player account server deducts the monetary value from the player account. The flow continues at block 1106.

At block 1106, the player account server transmits confirmation of the transaction. In some embodiments, the player account server transmits to the mobile device, purchasing station, or both, an indication that the transaction was successful.

Although examples refer to a player depositing the wagering game ticket associated with their player account into their own player account, in some embodiments, players can deposit wagering game tickets associated with another player's player account in their own player account. For example, Player A is playing a wagering game on a wagering game machine. At the end of the wagering game session, Player A cashes out and receives a wagering game ticket that is associated with Player A's player account. Player A wishes to give this wagering game ticket to Player B so that Player B can deposit the wagering game ticket in Player B's player account. When Player B attempts to deposit the wagering game ticket, the mobile device and/or player account server can determine that the wagering game ticket is associated with a player account that is not Player B's player account. The mobile device and/or player account server can then send an authorization code via email, SMS, MMS, etc. to Player A, and alert Player A that Player B is attempting to deposit the wagering game ticket in Player B's player account. If Player A authorizes this deposit, Player A can provide Player B with the authorization number provided by the mobile device or the player account server. Player B can then enter the authorization number, and the mobile device and/or player account server will continue with the deposit.

Although examples refer to capturing an image of the wagering game ticket, in some embodiments, the mobile device may already have an image of the wagering game ticket stored in its memory. For example, the mobile device can prompt the player to provide and image of the wagering game ticket. The mobile device can provide the player with the option to either take a picture of the wagering game ticket or use an existing image of the wagering game ticket. If the player chooses to use an existing image of the wagering game ticket, the mobile device can either process the existing image of the wagering game ticket or transmit the existing image of the wagering game ticket to the wagering game server.

Although examples refer to either the mobile device processing the image of the wagering game ticket or the player account server processing the image of the wagering game ticket, in some embodiments both the mobile device and the player account server can process the image of the wagering game ticket. In such embodiments, the mobile device can process the image of the wagering game ticket and transmit the information obtained from the wagering game ticket as well as the image of the wagering game ticket. Then player account server can then process the image of the wagering game ticket. The mobile device, player account server, or both, can then compare the information obtained by each entity to ensure accuracy.

Although examples refer to scanning and processing the wagering game ticket in the casino, in some embodiments, players may be able to deposit wagering game tickets from anywhere that the player account server can be accessed. For example, in some embodiments, players can use a mobile device to capture an image of a wagering game ticket at their home. The player can then connect to the player account server through the internet and either upload the image of the wagering game ticket or upload the information relating to the wagering game ticket to the player account server.

Although examples refer to performing security measures by accessing a database containing information related to printed wagering game tickets, in some embodiments, a password of other key may be linked with the wagering game ticket to enforce security. For example, in some embodiments, before the wagering game ticket is printed, the player can enter a password to be associated with the wagering game ticket. When the wagering game ticket is redeemed (e.g., deposited via a mobile device, presented to a cashier, inserted into a wagering game machine, etc.), the player is prompted to enter the password associated with the wagering game ticket. When the player enters the password correctly, the transaction can proceed. In other embodiments, a password or key may be assigned to the wagering game ticket at the time of printing by the wagering game machine, player account server, etc., and the password or key provided to the player. In other embodiments, at the time of printing, the wagering game machine printing the wagering game ticket can create an association between the wagering game ticket and the player's mobile device. For example, the wagering game machine can communicate with the player's mobile device via a near field communication (NFC) network (or by other suitable means). The wagering game machine can request an identification number from the mobile device. The mobile device's identification number can be associated with the wagering game ticket. When a player attempts to deposit the wagering game ticket via their mobile device, the player's mobile device's identification number will be referenced with the identification number of the mobile device associated with the wagering game ticket. Additionally, in some embodiments, when the wagering game ticket is inserted into another wagering game machine, in order for the funds associated with the wagering game ticket to be accessed, the wagering game machine will communicate with the player's mobile device to ensure that the wagering game ticket is being utilized by the same player that printed the wagering game ticket.

Although examples refer to security measures to ensure that a player seeking to utilize a wagering game ticket is authorized to utilize the wagering game ticket, in some embodiments, player-imposed restrictions may be set at the time of printing the wagering game ticket to limit the use of the wagering game ticket. For example, a player may indicate at the time of printing the wagering game ticket that the wagering game ticket is for deposit only (i.e., the wagering game ticket cannot be redeemed for cash, redeemed for wagering game play on wagering game machines, etc.). Further, the player may indicate that the wagering game ticket is for deposit only in a specific player account (i.e., the wagering game ticket can only be deposited in Player A's player account). Additionally, a player may indicate that the wagering game ticket cannot be redeemed for a predetermined period of time. For example, the player can indicate that the wagering game ticket cannot be redeemed during the subsequent two hours to enforce a break from gaming.

Although examples refer to a mobile device communicating with a print kiosk to print a wagering game ticket, in some embodiments the mobile device communicates with a player account server, and the player account server communicates with the print kiosk. For example, a player can indicate a request to print a wagering game ticket via the mobile device. The mobile device will forward this request to the player account server. The player account server will then verify that the player account has funds sufficient to fulfill the request. In some embodiments, the player account server will communicate with a ticketing server to receive a barcode, ticket number, or other ticket identifier that indicates a monetary value associated with the wagering game ticket. The player account server will then transmit all necessary information (e.g., player account information, ticket identifier, etc.) to the print kiosk for printing of the wagering game ticket.

Although examples refer to monetary value being associated with a wagering game ticket, in some embodiments non-monetary value can be associated with a wagering game ticket. For example, player reward points can be associated with a wagering game ticket. In such embodiments, a player can deposit the player reward points in a player account using the techniques described herein.

### Operating Environment

This section describes an example operating environment and presents structural aspects of some embodiments. This section includes discussion about wagering game networks and wagering game machine architectures.

### Wagering Game Networks

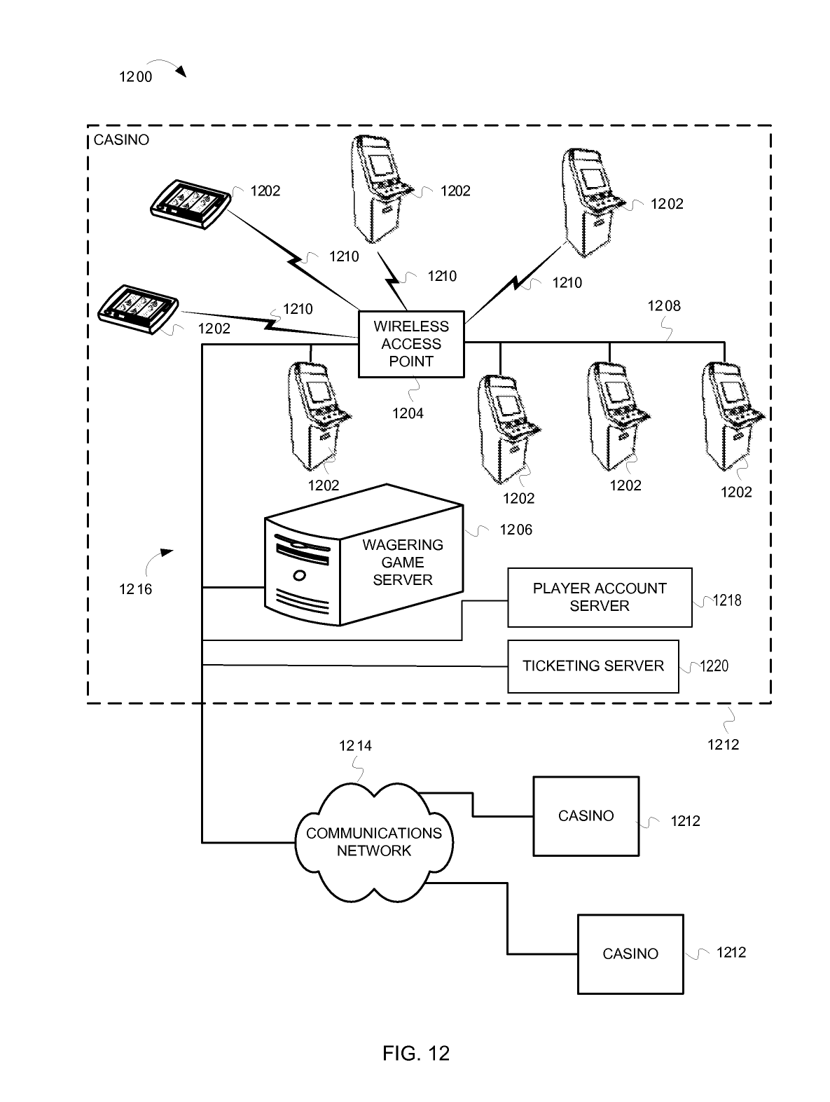

FIG. 12 is a block diagram illustrating a wagering game network 1200, according to example embodiments of the invention. As shown in FIG. 12, the wagering game network 1200 includes a plurality of casinos 1212 connected to a communications network 1214.

Each casino 1212 includes a local area network 1216, which includes an access point 1204, a wagering game server 1206, a player account server 1218, a ticketing server 1220, and wagering game machines 1202. The access point 1204 provides wireless communication links 1210 and wired communication links 1208. The wired and wireless communication links can employ any suitable connection technology, such as Bluetooth, 802.11, Ethernet, public switched telephone networks, SONET, etc. In some embodiments, the wagering game server 1206 can serve wagering games and distribute content to devices located in other casinos 1212 or at other locations on the communications network 1214.

The wagering game machines 1202 described herein can take any suitable form, such as floor standing models, handheld mobile units, bartop models, workstation-type console models, etc. Further, the wagering game machines 1202 can be primarily dedicated for use in conducting wagering games, or can include non-dedicated devices, such as mobile phones, personal digital assistants, personal computers, etc. In one embodiment, the wagering game network 1200 can include other network devices, such as accounting servers, wide area progressive servers, player tracking servers, and/or other devices suitable for use in connection with embodiments of the invention.

In some embodiments, wagering game machines 1202 and wagering game servers 1206 work together such that a wagering game machine 1202 can be operated as a thin, thick, or intermediate client. For example, one or more elements of game play may be controlled by the wagering game machine 1202 (client) or the wagering game server 1206 (server). Game play elements can include executable game code, lookup tables, configuration files, game outcome, audio or visual representations of the game, game assets or the like. In a thin-client example, the wagering game server 1206 can perform functions such as determining game outcome or managing assets, while the wagering game machine 1202 can present a graphical representation of such outcome or asset modification to the user (e.g., player). In a thick-client example, the wagering game machines 1202 can determine game outcomes and communicate the outcomes to the wagering game server 1206 for recording or managing a player's account.

In some embodiments, either the wagering game machines 1202 (client) or the wagering game server 1206 can provide functionality that is not directly related to game play. For example, account transactions and account rules may be managed centrally (e.g., by the wagering game server 1206) or locally (e.g., by the wagering game machine 1202). Other functionality not directly related to game play may include power management, presentation of advertising, software or firmware updates, system quality or security checks, etc. Additionally, in some embodiments, the player account server 1218 can store and provide access to player accounts. Additionally, the player account server 1218 can perform transactions relating to the player accounts. In some embodiments, the ticket server 1220 provides functionality relating to wagering game tickets, such as verifying wagering game tickets, producing wagering game tickets, determining monetary value associated with wagering game tickets, etc.

Any of the wagering game network components (e.g., the wagering game machines 1202) can include hardware and machine-readable media including instructions for performing the operations described herein.

### Wagering Game Machine Architectures

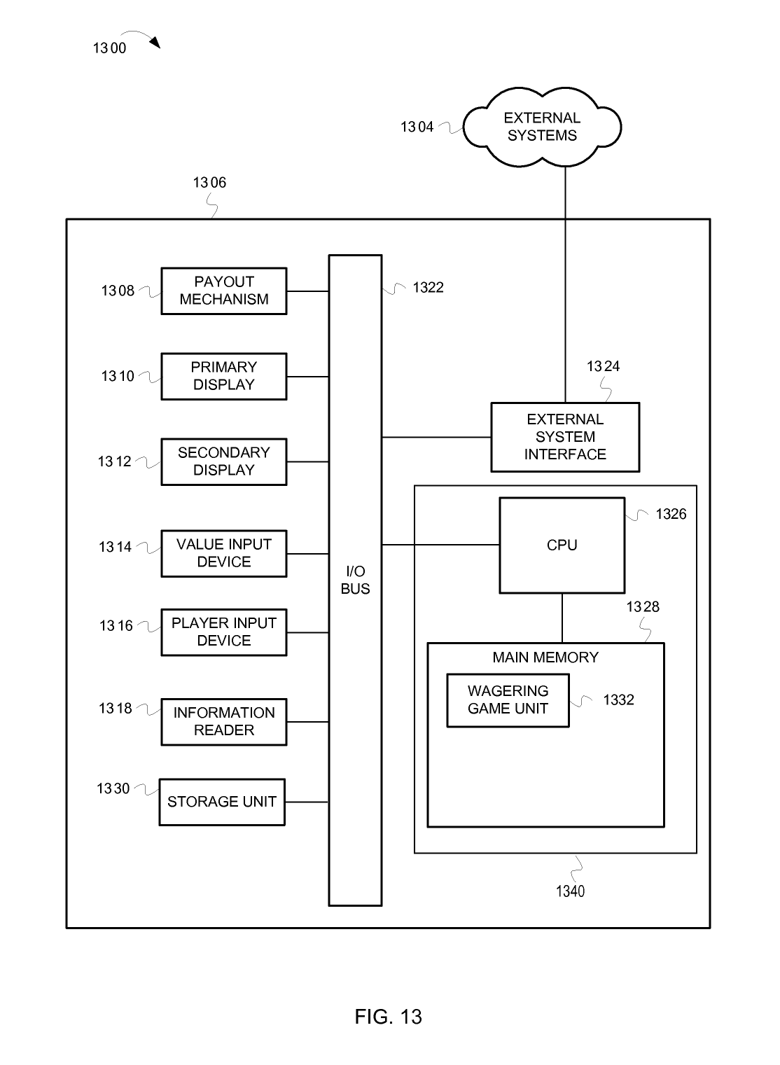

FIG. 13 is a block diagram illustrating a wagering game machine architecture, according to example embodiments of the invention. As shown in FIG. 13, the wagering game machine architecture 1300 includes a wagering game machine 1306, with game-logic circuitry 1340 securely housed within a locked box inside a gaming cabinet. The game-logic circuitry 1340 includes a central processing unit (CPU) 1326 connected to main memory 1328 that comprises one or more memory devices. The CPU 1326 can include any suitable processor(s), such as an Intel® Pentium processor, Intel® Core 2 Duo processor, AMD Opteron™ processor, or UltraSPARC processor. By way of example, the CPU 1326 includes a plurality of microprocessors including a master processor, a slave processor, and a secondary or parallel processor. Game-logic circuitry 1340, as used herein, comprises any combination of hardware, software, or firmware disposed in or outside of the wagering game machine 1306 that is configured to communicate with or control the transfer of data between the wagering game machine 1306 and a bus, another computer, processor, device, service, or network. The game-logic circuitry 1340, and more specifically the CPU 1326, comprises one or more controllers or processors and such one or more controllers or processors need not be disposed proximal to one another and may be located in different devices or in different locations. The game-logic circuitry 1340, and more specifically the main memory 1328, comprises one or more memory devices which need not be disposed proximal to one another and may be located in different devices or in different locations. The game-logic circuitry 1340 is operable to execute all of the various gaming methods and other processes disclosed herein. The main memory 1328 includes a wagering game unit 1332. In one embodiment, the wagering game unit 1332 can present wagering games, such as video poker, video black jack, video slots, video lottery, etc., in whole or part.

The game-logic circuitry 1340 (e.g., via the CPU 1326) is also connected to an input/output (I/O) bus 1322, which can include any suitable bus technologies, such as an AGTL+frontside bus and a PCI backside bus. The I/O bus 1322 is connected various input devices, output devices, and input/output devices, such as a payout mechanism 1308, a primary display 1310, a secondary display 1312, a value input device 1314, a player input device 1316, an information reader 1318, and a storage unit 1330. The player input device 1316 can include the value input device 1314 to the extent the player input device 1316 is used to place wagers. The I/O bus 1322 is also connected to an external system interface 1324, which is connected to external systems 1304 (e.g., wagering game networks). In some embodiments, the payout mechanism 1308 can include a ticket printer for printing wagering game tickets.

The external system(s) 1304 include, in various aspects, a gaming network, other gaming machines or terminals, a gaming server, a remote controller, communications hardware, or a variety of other interfaced systems or components, in any combination. In yet other aspects, the external system(s) 1304 comprise a player's portable electronic device (e.g., cellular phone, electronic wallet, etc.) and the external-system interface 1324 is configured to facilitate wireless communication and data transfer between the portable electronic device and the wagering game machine 1306, such as by a near-field communication path operating via magnetic-field induction or a frequency-hopping spread spectrum RF signals (e.g., Bluetooth, etc.).

The wagering game machine 1306 optionally communicates with the external system(s) 1304 such that the wagering game machine 1306 operates as a thin, thick, or intermediate client. The game-logic circuitry 1340≧whether located within (“thick client”), external to (“thin client”), or distributed both within and external to (“intermediate client”) the wagering game machine 1306—is utilized to provide a wagering game on the wagering game machine 1306. In general, the main memory 1328 stores programming for a random number generator (RNG), game-outcome logic, and game assets (e.g., art, sound, etc.)—all of which obtained regulatory approval from a gaming control board or commission and are verified by a trusted authentication program in the main memory 1328 prior to game execution. The authentication program generates a live authentication code (e.g., digital signature or hash) from the memory contents and compares it to a trusted code stored in the main memory 1328. If the codes match, authentication is deemed a success and the game is permitted to execute. If, however, the codes do not match, authentication is deemed a failure that must be corrected prior to game execution. Without this predictable and repeatable authentication, the wagering game machine 1306, external system(s) 1304, or both are not allowed to perform or execute the RNG programming or game-outcome logic in a regulatory-approved manner and are therefore unacceptable for commercial use.

When a wagering-game instance is executed, the CPU 1326 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 1326 when executing the game-outcome logic to determine a resultant outcome for that instance of the wagering game. The resultant outcome is then presented to a player of the wagering game machine 1306 by accessing the associated game assets, required for the resultant outcome, from the main memory 1328. The CPU 1326 causes the game assets to be presented to the player as outputs from the wagering game machine 1306 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player, for example, at a minimum of 100 Hz (100 calls per second) as set forth in Nevada's New Gaming Device Submission Package. Accordingly, the RNG cannot be carried out manually by a human.

The wagering game machine 1306 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

In some embodiments, the game-logic circuitry 1340 is configured to store and execute instructions, which can perform one or more algorithms, such as those described in association with flow diagrams mentioned herein. The algorithms can be used to perform operations to use, interact with, communicate with, and/or cooperate with mobile devices, casino kiosks, gaming servers, player account servers, additional wagering game machines, wearable computers, etc.

In one embodiment, the wagering game machine 1306 can include additional peripheral devices and/or more than one of each component shown in FIG. 13. For example, in one embodiment, the wagering game machine 1306 can include multiple external system interfaces 1324 and/or multiple CPUs 1326. In one embodiment, any of the components can be integrated or subdivided.

Any component of the architecture 1300 can include hardware, firmware, and/or machine-readable media including instructions for performing the operations described herein. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

While FIG. 13 describes an example wagering game machine architecture, this section continues with a discussion of wagering game devices and networks.

### Example Wagering Game Machines

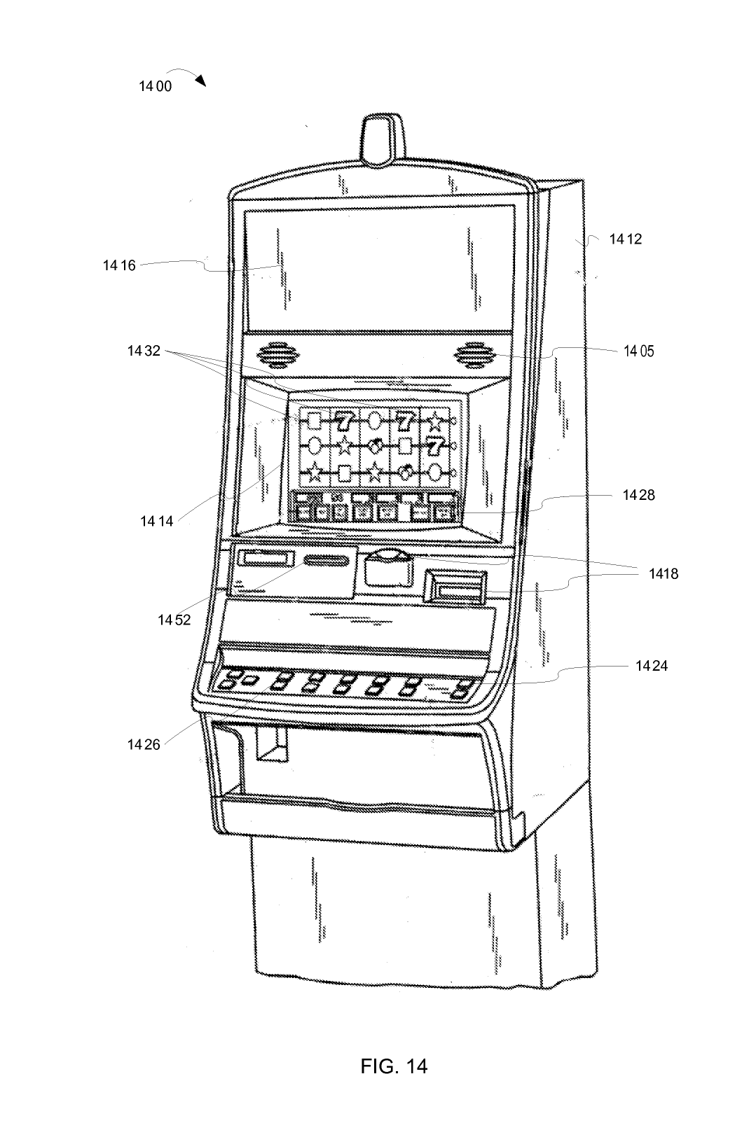

FIG. 14 is a perspective view of a wagering game machine, according to example embodiments of the invention. Referring to FIG. 14, a wagering game machine 1400 is used in gaming establishments, such as casinos. According to embodiments, the wagering game machine 1400 can be any type of wagering game machine and can have varying structures and methods of operation. For example, the wagering game machine 1400 can be an electromechanical wagering game machine configured to play mechanical slots, or it can be an electronic wagering game machine configured to play video casino games, such as blackjack, slots, keno, poker, blackjack, roulette, etc.

The wagering game machine 1400 comprises a housing 1412 that securely houses various input devices, output devices, input/output devices, internal electronic/electromechanical components, wiring, etc. The housing 1412 includes exterior walls, interior walls and shelves for mounting the internal components and managing the wiring, and one or more front doors that are locked and require a physical or electronic key to gain access to the interior compartment of the housing 1412 behind the locked door. In some examples, the housing 1412 forms an alcove configured to store one or more beverages or personal items of a player. The input devices, output devices, and input/output devices are disposed on, and securely coupled to, the housing 1412. By way of example, the input devices include value input devices 1418 and a player input device 1424. Other examples of input devices include a mouse, a joystick, a gesture-sensing device, a voice-recognition device, and a virtual input device. The input devices can accept player input and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element. For output, the wagering game machine 1400 includes a primary display 1414 for displaying information for a wagering game, such as a plurality of simulated symbol-bearing reels a plurality of mechanical reels, and/or other video or mechanical presentation consistent with a game format and theme. The wagering game content may also include one or more game-session credit meters and various touch screen buttons adapted to be actuated by a player. A player can operate or interact with the wagering game using the touch screen buttons or other input devices. Game-logic circuitry operates to execute a wagering-game program causing the primary display 1414 or the secondary display 1416 to display the wagering game. In response to receiving an input indicative of a wager, the reels are rotated and stopped to place symbols on the reels in visual association with paylines such as paylines. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the wagering game machine 1400, following receipt of an input from the player to initiate a wagering-game instance. The wagering game machine 1400 then communicates the wagering-game outcome to the player via one or more output devices (e.g., primary display 1414 or secondary display 1416) through the display of information such as, but not limited to, text, graphics, static images, moving images, etc., or any combination thereof. In accord with the method of conducting the wagering game, the game-logic circuitry transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the game-logic circuitry is configured to process the electronic data signal, to interpret the data signal (e.g., data signals corresponding to a wager input), and to cause further actions associated with the interpretation of the signal in accord with stored instructions relating to such further actions executed by the controller. As one example, a central processing unit (CPU) causes the recording of a digital representation of the wager in one or more storage media (e.g., a storage unit), the CPU, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU (e.g., the wager in the present example). As another example, the CPU further, in accord with the execution of the stored instructions relating to the wagering game, causes the primary display 1414, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry to determine the outcome of the wagering-game instance. In at least some aspects, the game-logic circuitry is configured to determine an outcome of the wagering-game instance at least partially in response to the random parameter. The primary display 1414 can also display information about a bonus wagering game and a progressive wagering game. The wagering game machine 1400 also includes a secondary display 1416 for displaying wagering game events, wagering game outcomes, and/or signage information. The primary display 1414 or the secondary display 1416 may be a mechanical-reel display device, a video display device, or a combination thereof, in which a transmissive video display is disposed in front of a mechanical-reel display to portray a video image superimposed upon the mechanical-reel display. The displays may variously display information associated with wagering games, non-wagering games, community games, progressives, advertisements, services, premium entertainment, text messaging, emails, alerts, announcements, broadcast information, subscription information, etc. appropriate to the particular mode(s) of operation of the wagering game machine 1400.

While some components of the wagering game machine 1400 are described herein, numerous other elements can exist and can be used in any number or combination to create varying forms of the wagering game machine 1400. For example, the wagering game machine 1400 may include one or more audio speakers 1405, video projection devices, three-dimensional (3D) devices, vibration devices, location tracking devices, player tracking devices, chairs, etc.

The value input devices 1418 can take any suitable form and can be located on the front of the housing 1412. The value input devices 1418 can receive currency and/or credits inserted by a player. The value input devices 1418 can include coin acceptors for receiving coin currency and bill acceptors for receiving paper currency. Furthermore, the value input devices 1418 can include ticket readers or barcode scanners for reading information stored on vouchers, cards, or other tangible portable storage devices. The vouchers or cards can authorize access to central accounts, which can transfer money to the wagering game machine 1400. Furthermore, the value input devices 1418 can include a wireless communication interface for reading cash or credit data from a nearby mobile device, and a network interface for withdrawing cash or credits from a remote account via an electronic funds transfer. The wagering game machine 1400 can also include value output devices used to dispense cash or credits from the wagering game machine 1400. The credits may be exchanged for cash at, for example, a cashier or redemption station. Examples of value output devices include, but are not limited to, a coin hopper for dispensing coins or tokens, a bill dispenser, a card reader/writer, a ticket dispenser for printing tickets redeemable for cash or credits, a wireless communication interface for transmitting cash or credit data to a nearby mobile device, and a network interface for depositing cash or credits to a remote account via an electronic funds transfer.

The player input device 1424 comprises a plurality of push buttons on a button panel 1426 for operating the wagering game machine 1400. In addition, or alternatively, the player input device 1424 can comprise a touch screen 1428 mounted over the primary display 1414 and/or secondary display 1416.

The various components of the wagering game machine 1400 can be connected directly to, or contained within, the housing 1412. Alternatively, some of the wagering game machine's components can be located outside of the housing 1412, while being communicatively coupled with the wagering game machine 1400 using any suitable wired or wireless communication technology.

The operation of the basic wagering game can be displayed to the player on the primary display 1414. The primary display 1414 can also display a bonus game associated with the basic wagering game. The primary display 1414 can include a cathode ray tube (CRT), a high resolution liquid crystal display (LCD), a plasma display, light emitting diodes (LEDs), or any other type of display suitable for use in the wagering game machine 1400. Alternatively, the primary display 1414 can include a number of mechanical reels to display the outcome. In FIG. 14, the wagering game machine 1400 is an “upright” version in which the primary display 1414 is oriented vertically relative to the player. Alternatively, the wagering game machine can be a “slant-top” version in which the primary display 1414 is slanted at about a thirty-degree angle toward the player of the wagering game machine 1400. In yet another embodiment, the wagering game machine 1400 can exhibit any suitable form factor, such as a free standing model, bartop model, mobile handheld model, or workstation console model.

A player begins playing a basic wagering game by making a wager via the value input device 1418. The player can initiate play by using the player input device's buttons or touch screen 1428. The basic game can include arranging a plurality of symbols along a payline 1432, which indicates one or more outcomes of the basic game. Such outcomes can be randomly selected in response to player input. At least one of the outcomes, which can include any variation or combination of symbols, can trigger a bonus game.

In some embodiments, the wagering game machine 1400 can also include an information reader 1452, which can include a card reader, ticket reader, bar code scanner, RFID transceiver, or computer readable storage medium interface. In some embodiments, the information reader 1452 can be used to award complimentary services, restore game assets, track player habits, etc.

In one embodiment, the wagering game machine 1400 and, additionally or alternatively, an external system (e.g., a gaming server), means gaming equipment that meets the hardware and software requirements for security and predictability as established by at least one state's gaming control board or commission. Prior to commercial deployment, the wagering game machine 1400, the external system, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in other gaming jurisdictions.

In some instance describe herein, a casino kiosk is described. The casino kiosk may include many, if not all, of the same components described in FIGS. 13 and 14. In some instances, the casino kiosk may include input and output devices configure primarily for adding funds to a gaming session and/or for dispensing funds from a gaming session. For instance, the casino kiosk may include any of the value input devices and/or value output devices described previously, as well as player input devices required to select options and features associated with the funds (e.g., a display configured to present a graphical user interface from which a player can access a virtual automated teller machine (ATM)).

### Processing E-Tickets

Typically, when a player wishes to cash out (i.e., remove any value remaining on a wagering game machine from the wagering game machine), the wagering game machine creates a physical ticket (e.g., prints a paper ticket) representing the value remaining on the wagering game machine. The player then takes the physical ticket to a cashier or kiosk to redeem the physical ticket for cash. Embodiments of the inventive subject matter create e-tickets that can be stored on a mobile device in addition to, or in lieu of, physical tickets. An e-ticket is a wagering game ticket that is stored electronically. E-tickets can include all information that a wagering game ticket includes (e.g., a unique identifier, a monetary value, a player account number, etc.). E-tickets can be redeemed using scanning systems. Scanning systems can be located, for example, at a cage or cashier station in a casino or at a kiosk. When a player wishes to cash out after playing wagering games on a mobile device, an e-ticket is created and stored on the player's mobile device. The player can redeem the e-ticket for cash by scanning the e-ticket using the scanning system. The scanning system can process a virtual image of an e-ticket (e.g., a graphical image), or can transmit the virtual image of the e-ticket for processing by other components. This discussion will continue with a description of embodiments that inter alia create, scan, and redeem e-tickets.

FIG. 15A depicts a system for creating an e-ticket for storage on a mobile device 1504. The system includes a mobile device 1504, a wagering game server 1506, a player account server 1508, and a ticketing server 1502. FIG. 15A depicts operations at stages A-E. The stages are examples and are not necessarily discrete occurrences over time (e.g., operations of different stages may overlap). Additionally, some embodiments of the inventive subject matter may include different stages than those depicted in Figured 15A (e.g., additional stages, fewer stages, etc.).

At stage A, the mobile device 1504 transmits an indication to generate an e-ticket to the wagering game server 1506. For example, when a player requests to cash out on the mobile device 1504, the mobile device 1504 transmits an indication to generate an e-ticket to the wagering game server 1506.

At stage B, the wagering game server 1506 determines monetary value information for the e-ticket. For example, the monetary value information can include the player's balance at the time the player wishes to cash out. Embodiments of the system can store account balances in different ways. For example, some embodiments create game session accounts for tracking session balances. In such embodiments, the monetary value information is stored on the wagering game server 1506. For example, when the player deposits monetary value to initiate a wagering game session on the mobile device 1504, an account (e.g., a game session account) is created for the wagering game session, where the account exists for the duration of the wagering game session. In some embodiments, the account is not associated with a specific player. Rather, the account may be linked to the mobile device 1504 based on a unique identifier for the mobile device 1504 (e.g., the mobile device's 1504 MAC address). Alternatively, the account may be linked to a session identifier known by the mobile device 1504 and the wagering game server 1506. As the player plays wagering games during the wagering game session, an account balance for the account is updated on the wagering game server, based on results of the wagering games.

In other embodiments, the monetary value information is stored on the player account server 1508. For example, during an account-based wagering game session, when the player deposits money to initiate a wagering game session on the mobile device 1504, the player account server 1508 updates a persistent player account associated with the player to reflect the deposit. The player account server 1508 updates a balance of the player account as the player plays wagering games during the wagering game session. In such embodiments, the wagering game server determines the monetary value information by requesting the balance of the player account from the player account server 1508. In response, the player account server 1508 transmits the monetary value information (i.e., the balance of the player account) to the wagering game server 1506.

At stage C, the wagering game server 1506 requests e-ticket information from the ticketing server 1502. For example, the wagering game server 1506 transmits the monetary value information to the ticketing server 1502 and requests e-ticket information based on the monetary value information from the ticketing server 1502. In response to the request for e-ticket information, the ticketing server 1502 creates the e-ticket information. The e-ticket information associates the e-ticket with an indication of the monetary value information stored on the ticketing server 1502. For example, the ticketing server 1502 can maintain a database of voucher numbers (or other suitable unique identifiers) and the monetary value associated with each voucher number. In this example, the e-ticket information would include the voucher number that is associated with the monetary value for the e-ticket. After creating the e-ticket information, the ticketing server 1502 transmits the e-ticket information to the wagering game server 1506.

At stage D, the wagering game server 1506 receives the e-ticket information from the ticketing server 1502. In some embodiments, after receiving the e-ticket information, the wagering game server 1506 creates a virtual image of the e-ticket 1510. In such embodiments, at stage E, the wagering game server 1506 transmits the virtual image of the e-ticket 1510 to the mobile device 1504. In other embodiments, at stage E, the wagering game server 1506 transmits the e-ticket information to the mobile device 1504. In such embodiments, the mobile device 1504 creates a virtual image of the e-ticket 1510 based on the e-ticket information.

FIG. 15B depicts redeeming an e-ticket stored on a mobile device 1514 using a scanning system 1512. As previously discussed, when a player cashes out, typical wagering game systems create a physical ticket representing monetary value remaining on a wagering game machine. The player takes the physical ticket to a cashier and redeems the physical ticket for cash. According to some embodiments of the inventive subject matter, the player can present a virtual image of an e-ticket 1518 to a scanning system 1514 to redeem the e-ticket for cash.

The scanning system 1514 can include a scanner or any other mechanism for capturing information presented on the mobile device 1516 or receiving information transmitted by the mobile device 1516. Scanning systems can be used by casino personal, for example, at a cashier or cage in a casino. Additionally, kiosks can be equipped with scanning systems to provide automated redemption of e-tickets. The player (or a cashier) places the mobile device 1516 in view of a scanner of the scanning system 1514. The scanner of the scanning system 1514 scans the virtual image of the e-ticket 1518 to acquire the e-ticket information contained in the virtual image of the e-ticket 1518. In some embodiments, the scanning system 1514 captures an image of the virtual image of the e-ticket 1518. In other embodiments, the scanning system 1514 reads the e-ticket information off of the virtual image of the e-ticket 1518 (e.g., using character recognition technology). The e-ticket information contained in the virtual image of the e-ticket 1518 can take any suitable form. For example, the information can be a one-dimensional barcode, a two-dimensional barcode, an alphanumeric code, etc. Furthermore, the e-ticket information can be the voucher number assigned to the e-ticket, or can be a different unique identifier. For example, when the player begins a wagering game session by depositing money, the deposit can be assigned a unique six digit number. When an e-ticket is created (e.g., when the player deposits additional money, cashes out, etc.), the voucher number associated with the e-ticket can be linked to the six digit number. In such embodiments, although a new e-ticket is created for each transaction, the original six digit number associated with the deposit persists.

In some embodiments, the scanning system 1514 must decode the virtual image of the e-ticket 1518 to obtain the e-ticket information. For example, if the e-ticket information is contained in a barcode, the scanning system 1514 decodes the barcode to obtain the e-ticket information. The scanning system 1514 then transmits the e-ticket information to the ticketing server 1512. The ticketing server 1512 verifies the e-ticket information and transmits a verification message back to the scanning system 1514. For example, the ticketing server 1512 can access a database containing voucher numbers to verify that the e-ticket is not fraudulent and that the e-ticket has not previously been redeemed. After receiving the verification message from the ticketing server 1512, the scanning system 1514 can redeem the e-ticket. For example, if the scanning system 1514 is part of a kiosk, the scanning system 1514 can instruct the kiosk to dispense cash to the player. If the scanning system 1514 is used by a cashier in a casino, the scanning system 1514 can instruct the cashier to distribute cash to the player.

Although the discussion of FIG. 15B refers to the scanning system 1514 optically obtaining the e-ticket information, embodiments are not so limited. For example, the mobile device 1516 can communicate the e-ticket information to the scanning system 1514 via a wireless transmission (e.g., Bluetooth, NFC, WiFi, etc.) or audibly. In such embodiments, the scanning system 1514 decodes the transmission and transmits the e-ticket information to the ticketing server 1512.

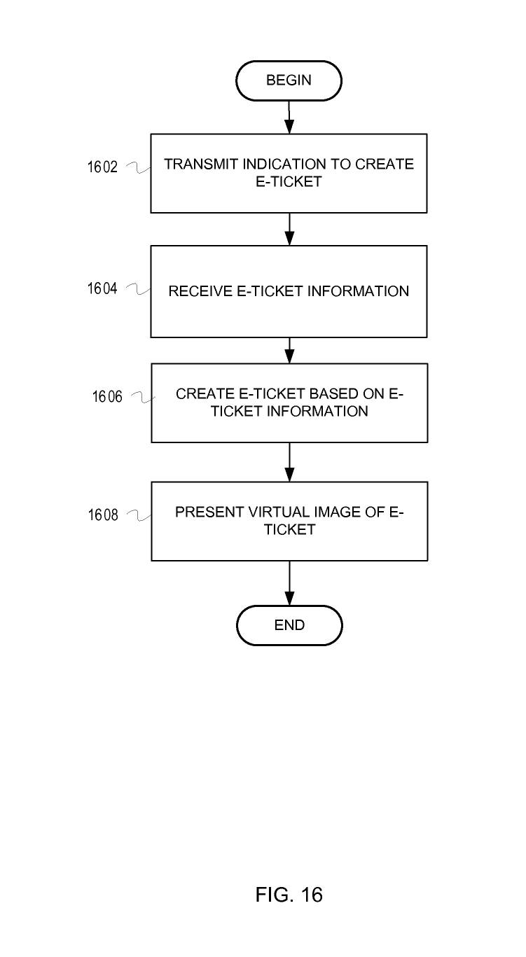

FIG. 16 is a flow diagram depicting example operations for creating an e-ticket for storage on a mobile device and redeeming the e-ticket, according to example embodiments of the invention. The flow begins at block 1602.

At block 1602, a mobile device transmits an indication to create an e-ticket to a wagering game server. For example, when a player presses a “cash out” button on the mobile device, the mobile device can transmit an indication to create an e-ticket to the wagering game server. The player can redeem the e-ticket using a scanning system. The e-ticket is similar to a conventional physical wagering game ticket. However, a mobile device stores the e-ticket so that the player does not have to keep track of a physical ticket. The flow continues at block 1604.

At block 1604, the mobile device receives e-ticket information from the wagering game server. In some embodiments, the e-ticket information is a voucher number that has been assigned to the e-ticket. Additionally, the e-ticket information can include monetary value information (i.e., the value of the e-ticket), player account information, a player identifier, etc. The flow continues at block 1606.

At block 1606, the mobile device creates an e-ticket based on the e-ticket information. For example, the mobile device generates a unique identifier (e.g., a barcode) based on the e-ticket information. Like a conventional physical wagering game ticket, the e-ticket can include the unique identifier, an indication of the e-ticket value, the name of the player associated with the e-ticket, and the player's player account number. It is not necessary however that the e-ticket include all of this information. For example, in embodiments in which a game session account is linked to a mobile device (as opposed to a specific player), the e-ticket may not be linked to a specific player. In such embodiments, the e-ticket may only include the unique identifier. Additionally, in some embodiments, the e-ticket can include more information than is listed above (e.g., a timestamp, a casino name, etc.). The mobile device compiles all of the information to be included in the e-ticket and creates the e-ticket based on the information. The flow continues at block 1608.

At block 1608, the mobile device presents a virtual image of the e-ticket. The mobile device can present the virtual image of the e-ticket to the player, or the mobile device can present the virtual image of the e-ticket to a scanning system to redeem the e-ticket. As previously discussed, in some embodiments, the mobile device does not visually present the virtual image of the e-ticket to a scanning system. For example, the mobile device can transmit the e-ticket information to the scanning system using any suitable means (e.g., Bluetooth, NFC, WiFi, etc.).

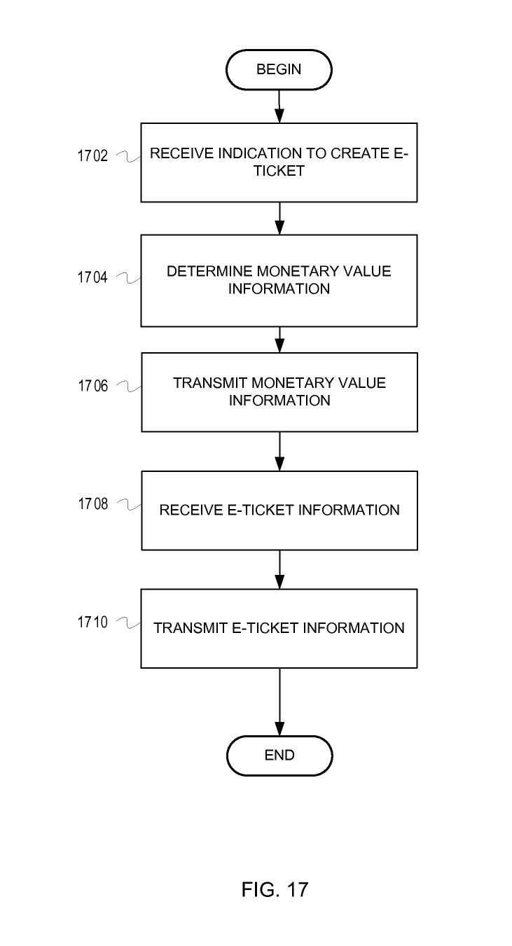

FIG. 17 is a flow diagram depicting example operations for creating an e-ticket for storage on a mobile device, according to example embodiments of the invention. The flow begins at block 1702.

At block 1702, a wagering game server receives an indication to create an e-ticket from a mobile device. The flow continues at block 1704.

At block 1704, the wagering game server determines monetary value information for the e-ticket. In some embodiments, the wagering game server stores a balance for a player. For example, some embodiments can create game session accounts for tracking session balances. In such embodiments, the monetary balance information may be stored on the wagering game server. For example, when the player deposits money to initiate a wagering game session, the wagering game server creates an account that is associated with the mobile device. The account can be associated with the mobile device based on a unique identifier for the mobile device (e.g., the mobile device's MAC address). In such embodiments, the wagering game server determines the monetary value information by accessing a database (or other data structure) to determine the balance for the account. In other embodiments, accounts are associated with players. In such embodiments, a player account server stores persistent account balances for a persistent player account. When a player deposits money to initiate a wagering game session, the player account server updates a balance of the player account to reflect the deposit. The wagering game server determines the monetary value information by querying the player account server. The wagering game server receives the monetary value information from the player account server. In some embodiments, in addition to determining the monetary value information, the wagering game server determines player account information. For example, the wagering game server can request a player identifier, a player name, etc. from the player account server. The flow continues at block 1706.

At block 1706, the wagering game server transmits the monetary value information to a ticketing server. The ticketing server generates e-ticket information based on the monetary value information. The e-ticket information associates the e-ticket with the monetary value information stored on the ticketing server for the e-ticket. For example, the e-ticket information can include a voucher number that is assigned to the e-ticket. The flow continues at block 1708.

At block 1708, the wagering game server receives the e-ticket information from the ticketing server. The flow continues at block 1710.

At block 1710, the wagering game server transmits the e-ticket information to the mobile device. In some embodiments, the wagering game server also transmits the player account information to the mobile device. Although the discussion of FIG. 16 describes creation of an e-ticket by a mobile device, in some embodiments, the wagering game server creates the e-ticket. In such embodiments, the wagering game server creates the e-ticket and transmits the e-ticket, or a virtual image of the e-ticket, to the mobile device.

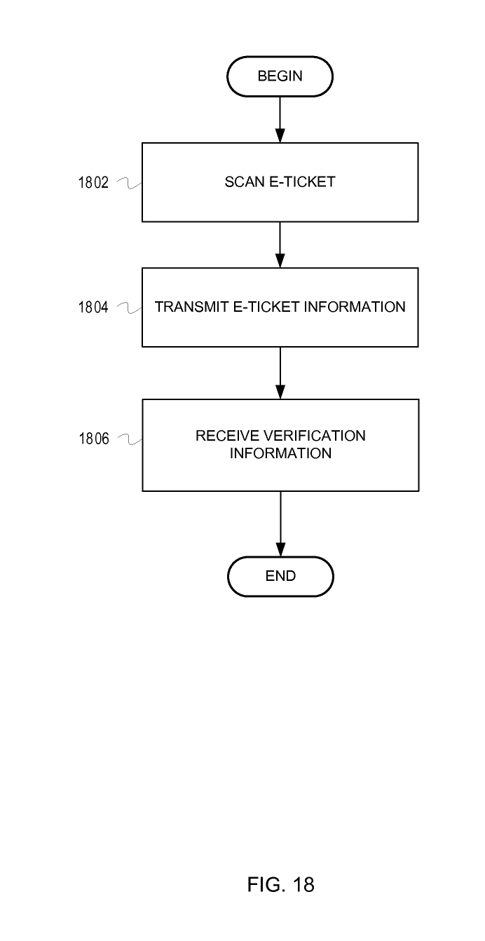

FIG. 18 is a flow diagram depicting example operations for redeeming an e-ticket stored on a mobile device using a scanning system, according to example embodiments of the invention. The flow begins at block 1802.

At block 1802, the scanning system scans the e-ticket. In some embodiments, the scanning system includes a visual scanner (e.g., an optical laser scanner) and the visual scanner scans the virtual image of the e-ticket from the mobile device. In other embodiments, the scanning system receives e-ticket information associated with the e-ticket by non-visual means. For example, the scanning system can include a microphone and the mobile device audibly transmits the e-ticket information to the mobile device. As another example, the scanning system can receive the e-ticket information from the mobile device via a wireless transmission (e.g., Bluetooth, NFC, WiFi, etc.). As another example, the scanning system can receive the e-ticket information via user input. In such embodiments, the player or a casino employee can manually enter the e-ticket information at the scanning system. Additionally, in some embodiments, after scanning the virtual image of the e-ticket (or otherwise receiving the e-ticket information), the scanning system decodes the virtual image of the e-ticket to determine the e-ticket information. For example, if the e-ticket information is contained in a barcode, the scanning system decodes the barcode to obtain the e-ticket information. The flow continues at block 1804.

At block 1804, the scanning system transmits the e-ticket information to a ticketing server. The ticketing server can verify the authenticity of the e-ticket by referencing the e-ticket information against a list of voucher numbers. The ticketing server can also verify that the e-ticket has not previously been redeemed, has not expired, etc. In some embodiments, the scanning system transmits the virtual image of the e-ticket to the ticketing server. In such embodiments, the ticketing server processes (e.g., decodes) the virtual image of the e-ticket to determine the e-ticket information. The flow continues at block 1806.

At block 1806, the scanning system receives verification information from the ticketing server. If the ticketing server determines that the e-ticket is valid and has not previously been redeemed, the ticketing server can transmit a verification message to the scanning system indicating that the e-ticket is valid and has not previously been redeemed. After the scanning system receives the verification information from the ticketing server, the scanning system can distribute money to the player, or instruct a casino employee to distribute money to the player.

### Mobile Gaming

The following describes examples of making funds available for anonymous play of wagering games on a mobile device, such as without requiring a player account or a specific player identifier. For example, some embodiments include a kiosk, a mobile device, a gaming server, and a casino accounting system. A cash input is made at the kiosk (e.g., a player enters cash into cash receiving devices, a player initiates an electronic cash transaction, such scanning a ticket or coupon code, swiping a gift card, making an electronic funds transfer (e.g., via an ATM transaction, a bank account transfer, a credit card transaction, etc.), and so forth. The gaming server detects an amount of the cash input and generates a unique tracking identifier. The gaming server communicates with a casino accounting system, such as one that utilizes the Slot Accounting System (“SAS”) protocol by International Game Technology (IGT) or the Game to System (G2S) protocol by the Gaming Standards Association. One such example of a casino accounting system is the Ticket-In/Ticket-Out (“TITO”) System, which uses the aforementioned TITO technology. The gaming server initiates a first vending process with the casino accounting system for the amount of the cash input. The casino accounting system stores the amount of the cash input as a monetary value associated with a casino accounting system identifier provided by the casino accounting system (e.g., a TITO identifier). The gaming server associates the TITO identifier with the unique tracking identifier. The gaming server communicates the unique tracking identifier to the casino kiosk. A mobile device links with the kiosk using the unique tracking identifier and specifies a mobile device identifier. The gaming server then initiates a second vending process with the casino accounting system to obtain the monetary value for the cash input and store it for future use. Thereafter, the gaming server communicates with the kiosk and the mobile device using the unique tracking identifier generated by the gaming server. The unique tracking identifier may be referred to herein generally as an electronic tracking identifier (“E-tracking ID”), or, in more specific instances, as an electronic Ticket-In/Ticket-Out identifier (“E-TITO ID”) or a “Cash Play” identifier. The gaming server also uses the mobile device identifier or “mobile ID” to conduct betting transactions for wagering games played on the mobile device during the mobile gaming session. When the mobile gaming session ends, the gaming server initiates one or more additional procedures to cash out an updated amount for the monetary value with the casino accounting system (e.g., to cash out a gaming session balance). The casino accounting system provides the gaming server an updated identifier (e.g. TITO identifier) that references the updated monetary value. This updated casino accounting system identifier (e.g. TITO identifier) is then associated with the electronic tracking identifier. The mobile device, in conjunction with the gaming server, can then use the electronic tracking identifier to retrieve the updated casino accounting system identifier and associated monetary value at a later time (e.g. next game session). In addition, the kiosk can call into the gaming server using the electronic tracking identifier to retrieve the current casino accounting system identifier. Upon retrieval of the casino accounting system identifier the kiosk can call into the Casino accounting system to retrieve the monetary value associated with the casino accounting system identifier and then print out a ticket, dispense cash, add to a card, etc.

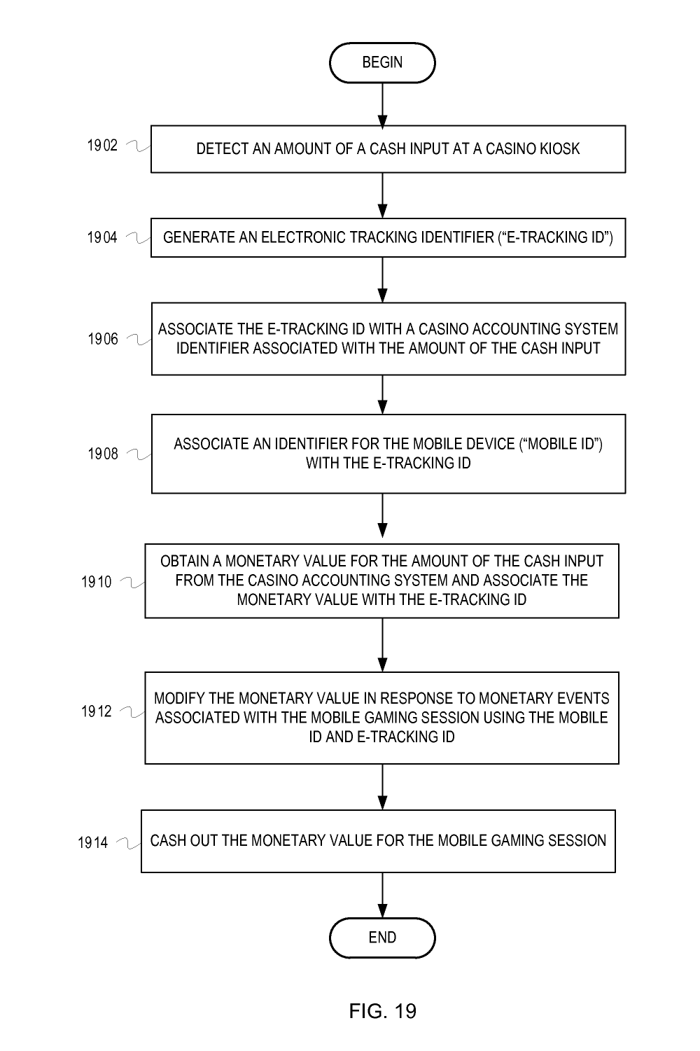

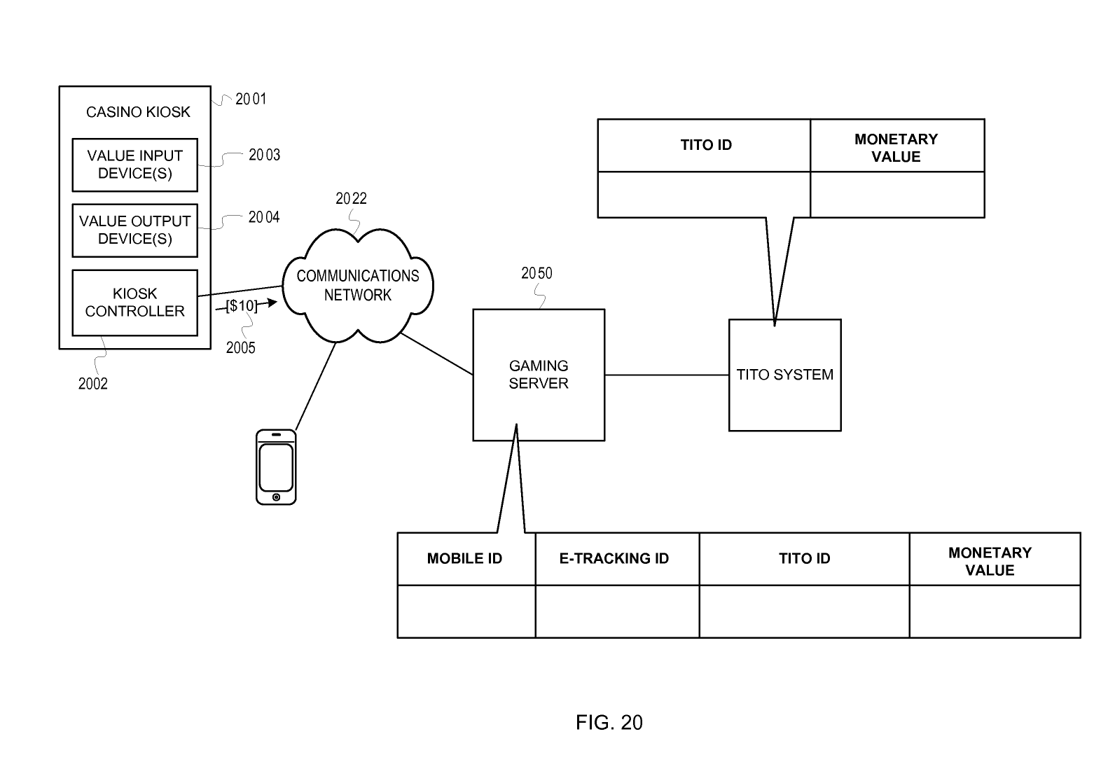

FIG. 19 is a flow diagram (“flow”) 1900 illustrating mobile electronic gaming according to some embodiments. FIGS. 20-38 are conceptual diagrams that help illustrate the flow of FIG. 19, according to some embodiments. This description will present FIG. 19 in concert with FIGS. 20-38. In FIG. 19, the flow 1900 begins at processing block 1902, where a gaming server detects an amount of a cash input at a casino kiosk. A funds-input transaction occurs at a casino kiosk. For instance, a cash input occurs at the kiosk, such as by inserting cash money into a bill/coin acceptor attached to the kiosk, swiping a card at a card reader attached to the kiosk, scanning a ticket via a scanning device at the kiosk, etc. In some instances, the casino kiosk includes a user interface where a control (e.g., a “Vend” button) can be selected to make the cash input. The gaming server can detect the funds-input transaction (e.g., in response to selection of the “Vend” button). For example, as depicted in FIG. 20, $10 in cash is input into a kiosk 2001 via one or more value input device(s) 2003 (e.g., a bill acceptor or any other value input device described herein) attached to a housing of the kiosk 2001. One or more value output device(s) 2004 (e.g., a ticket printer or any other value output device described herein), are also attached to the housing of the kiosk 2001. A kiosk controller 2002 detects the cash input and transmits a message, via a communications network 2022, to a gaming server 2050. The message indicates a monetary value 2005 in the amount of the cash input. The gaming server 2050 is connected to the kiosk 2001 via a secure network connection. The gaming server 2050 detects cash input and determines the monetary value 2005 (i.e., the $10 funds amount indicated in the message). In some examples, the gaming server 2050 is a combination of one or more servers, devices, etc. Furthermore, in some examples, the gaming server 2050 includes multiple components, such as one or more electronic processing units, (e.g., one or more central processing units (CPUs) or one or more graphical processing units (GPUs)), a network communication interface, hardware, software, firmware, game logic, memory storage units, etc.

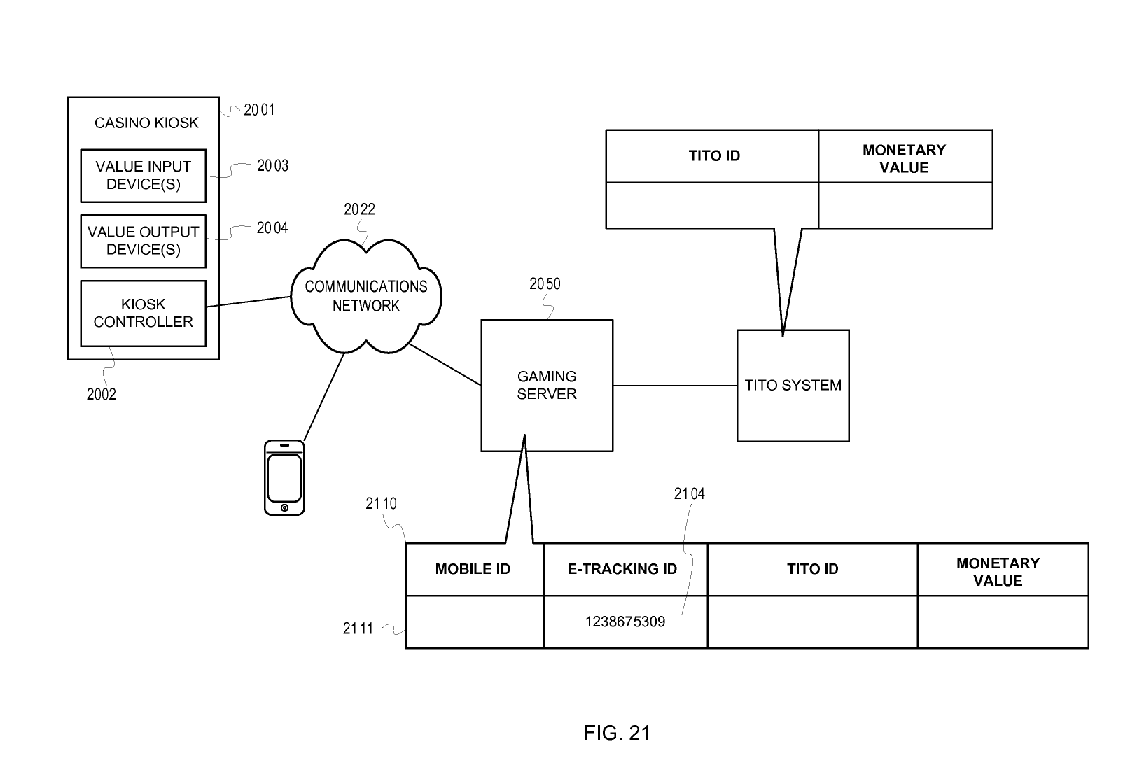

Referring back to FIG. 19, the flow 1900 continues at processing block 1904, where the gaming server generates an electronic tracking identifier. After detecting the cash input, the gaming server generates a unique electronic identifier to track and use the funds that were input at the kiosk. For instance, as depicted in FIG. 21, the gaming server 2050 generates a unique 10-digit electronic tracking identifier 2104 (“E-tracking ID 2104”) and stores the E-tracking ID 2104 in a data storage structure (e.g., in a record 2111 of a database 2110) at the gaming server 2050.

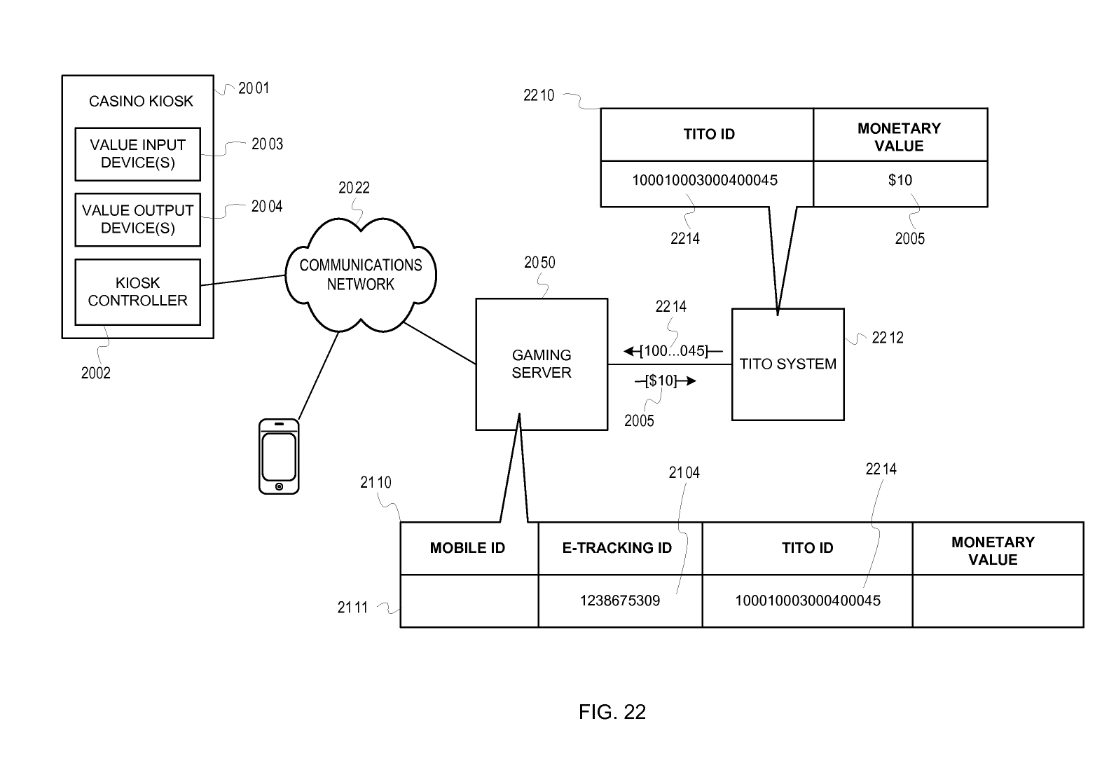

Referring back to FIG. 19, the flow 1900 continues at processing block 1906, where the gaming server associates the electronic tracking identifier with a casino accounting system identifier associated with the amount of the cash input. For example, as shown in FIG. 22, the gaming server 2050 electronically transmits an indication of the monetary value 2005 to a TITO system 2212 using the SAS protocol. For example, the gaming server 2050 can provide a Cash-Out SAS command to the TITO system 2212. The TITO system 2212 receives the Cash-Out SAS command and the TITO system 2212 generates a casino accounting system identifier, such as an 18-digit unique TITO identifier (e.g., “TITO identifier 2214”). The TITO system 2212 stores the TITO identifier 2214 and the monetary value 2005 in a data storage structure (e.g., a database 2210) accessible to the TITO system 2212. The TITO system 2212 then provides the TITO identifier 2214 to the gaming server 2050. The gaming server 2050 receives an indication of the TITO identifier 2214 and stores the TITO identifier 2214 in the record 2111 of the database 2110 that is associated with the E-tracking ID 2104.

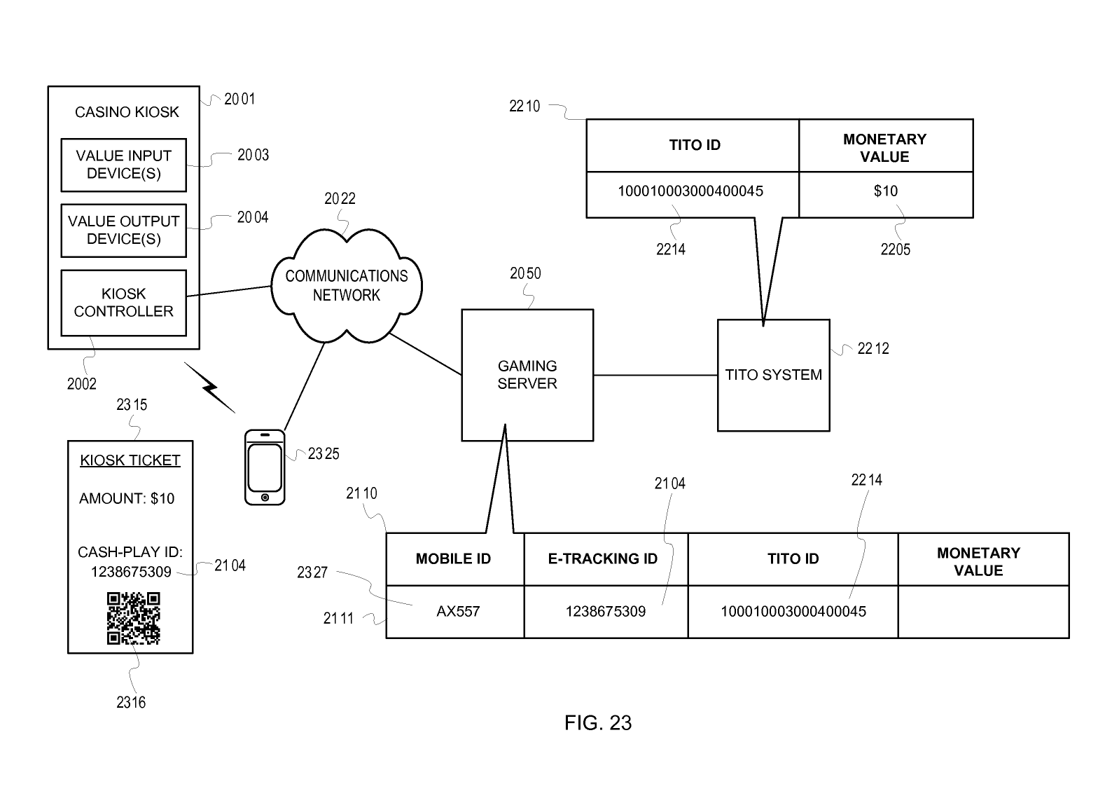

Referring back to FIG. 19, the flow 1900 continues at processing block 1908, where the gaming server associates a mobile device identifier for the mobile device with the electronic tracking identifier. In some embodiments, as depicted in FIG. 23, after the gaming server 2050 associates the E-tracking ID 2104 with the TITO identifier 2214, the gaming server 2050 transmits the E-tracking ID 2104 to the kiosk controller 2002. The kiosk controller 2002 then communicates the E-tracking ID 2104 in a manner that can be detected by and/or associated with a mobile device 2325. For example, as depicted in FIG. 23, the kiosk 2001 may print out a physical ticket 2315 via the one or more value output device(s) 2004 (e.g., a ticket printer). The ticket 2315 includes a scannable code (e.g., 2D bar code 2316). The 2D bar code 2316 includes information, such as an indication of the E-tracking ID 2104. The mobile device 2325 can scan the 2D barcode 2316 using a camera and a scanning application of the mobile device 2325. In some instances, the kiosk 2001, or gaming server 2050 may communicate the E-tracking ID 2104 to the mobile device 2325 via text message based on mobile number input into a user interface of the kiosk 2325. In some instances, the mobile device 2325 interfaces with the kiosk 2001 and transmits an identifier for the mobile device (“mobile ID 2327”) to the kiosk 2001 as well as the E-tracking ID 2104. In some instances, the mobile ID 2327 is a MAC address for the mobile device 2325. In other instances, the mobile ID 2327 is generated (e.g., via an application on the mobile device 2325 or via the kiosk 2001) when an application is installed on the mobile device 2325. The mobile ID 2327 can be generated at other times, such as when the mobile device 2325 enters a casino, when the mobile device 2325 interfaces with the kiosk 2001, etc. In some instances, the mobile device 2325 may register with the gaming server 2050 and the gaming server 2050 can generate the mobile ID 2327. In some instances, the gaming server 2050 can generate the mobile ID 2327 and provide it to the kiosk 2001 to transmit to the mobile device 2325. In some instances, the mobile device 2325 can store the mobile ID 2327 for use in multiple mobile gaming sessions. In other instances, the mobile ID 2327 can be regenerated for each mobile gaming session. In the instance where the mobile device 2325 and/or the kiosk 2001 generates or detects the mobile ID 2327, the kiosk 2001 transmits the mobile ID 2327 and the E-tracking ID 2104 back to the gaming server 2050. Using the information provided by the kiosk 2001, the gaming server 2050 can look up the E-tracking ID 2104 in the database 2110 and associate the mobile ID 2327 with the E-tracking ID 2104 in the database 2110 (e.g., store the mobile ID 2327 in the record 2111).

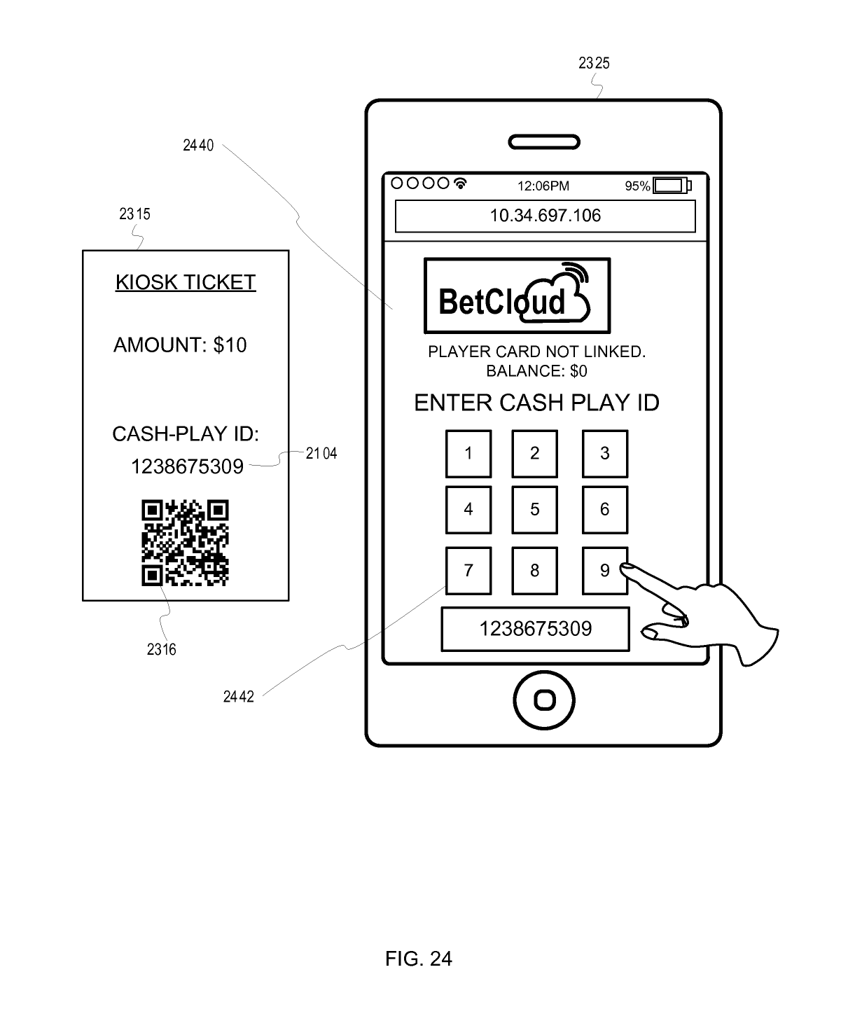

FIG. 23 illustrates only one example of how the mobile ID 2327 can be associated with the E-tracking ID 2104. FIG. 24 illustrates another example of associating the mobile ID 2327 with the E-tracking ID 2104. In FIG. 24, the kiosk prints onto the ticket 2315 an alphanumeric representation of the E-tracking ID 2104. The alphanumeric representation of the E-tracking ID 2104 can then be entered into the mobile device 2325 via a graphical user interface 2440 (e.g., by selecting graphical buttons 2442 using a touch screen of the mobile device 2325). In some instances, a user may generate a personal identification number (“PIN”) on the kiosk 2001 when inserting funds. The PIN is associated with the E-tracking ID 2104 in the gaming system. The PIN can be required for entry on the mobile device 2325 when accessing the funds associated with the E-tracking ID 2104.

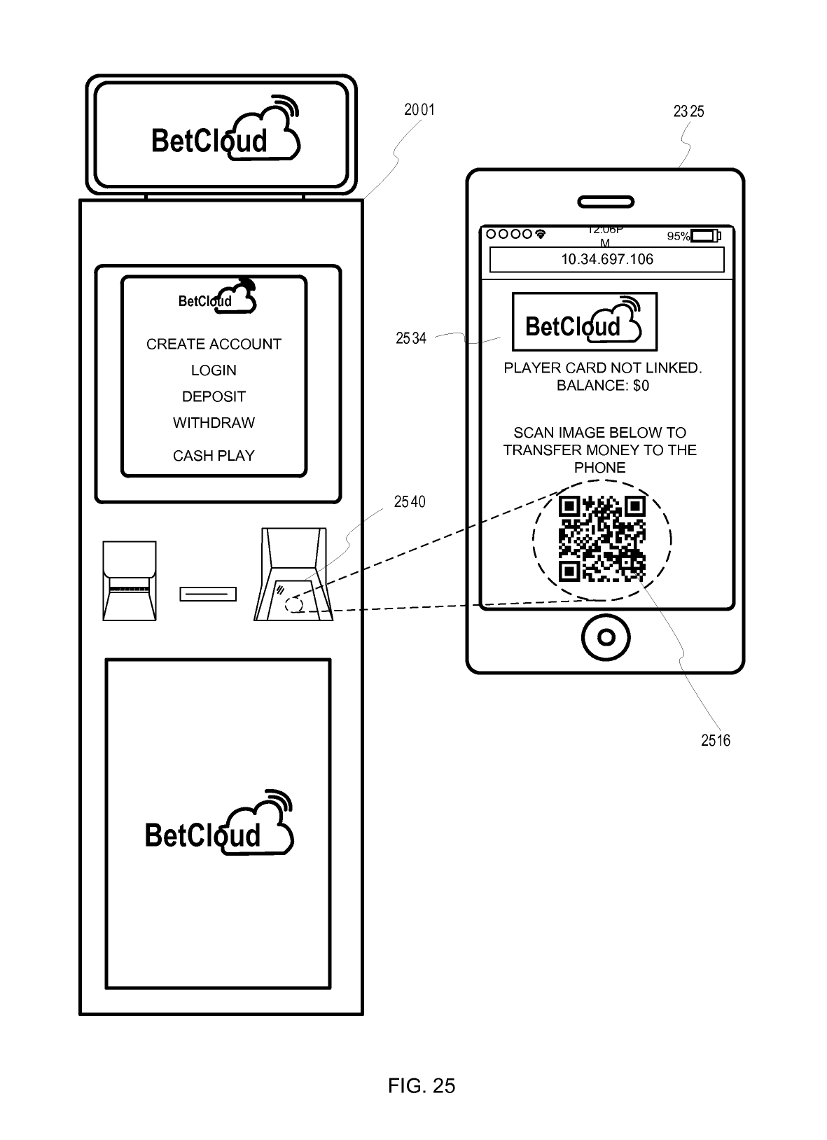

FIG. 25 illustrates another example of associating the mobile ID 2327 with the E-tracking ID 2104. In FIG. 25, the mobile device 2325 can link wirelessly to the kiosk 2001, such as via a Bluetooth™ Low-Energy (BLE) connection, a near-field communication(NFC) link, by scanning a code on the kiosk 2001, etc. The mobile device 2325 presents a 2D barcode 2516 on the display of the mobile device 2325 via an application 2534 running on the mobile device 2325. When the 2D barcode 2516 is placed within scanning distance to a scanning device 2540 of the kiosk 2001, the scanning device 2540 detects the 2D barcode 2516 and links wirelessly with the mobile device 2325. The mobile device 2325 can transmit the mobile ID 2327 to the kiosk 2001 via the wireless link. The kiosk 2001 can then transmit the mobile ID 2327 to the gaming server 2050.

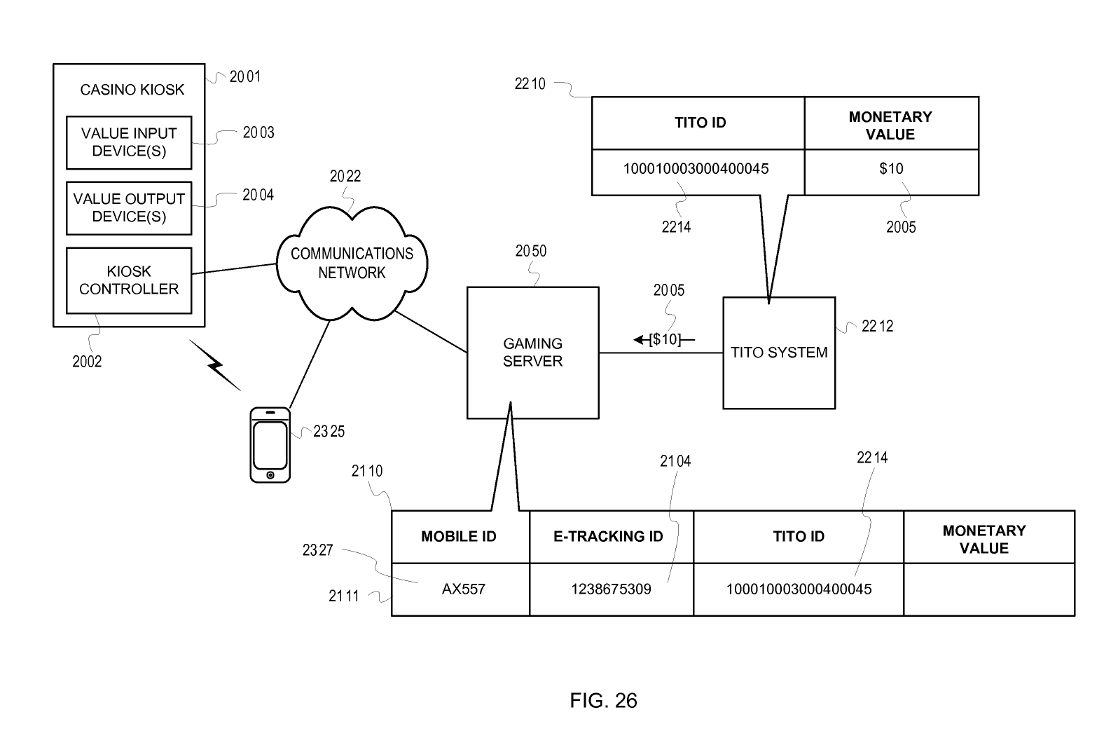

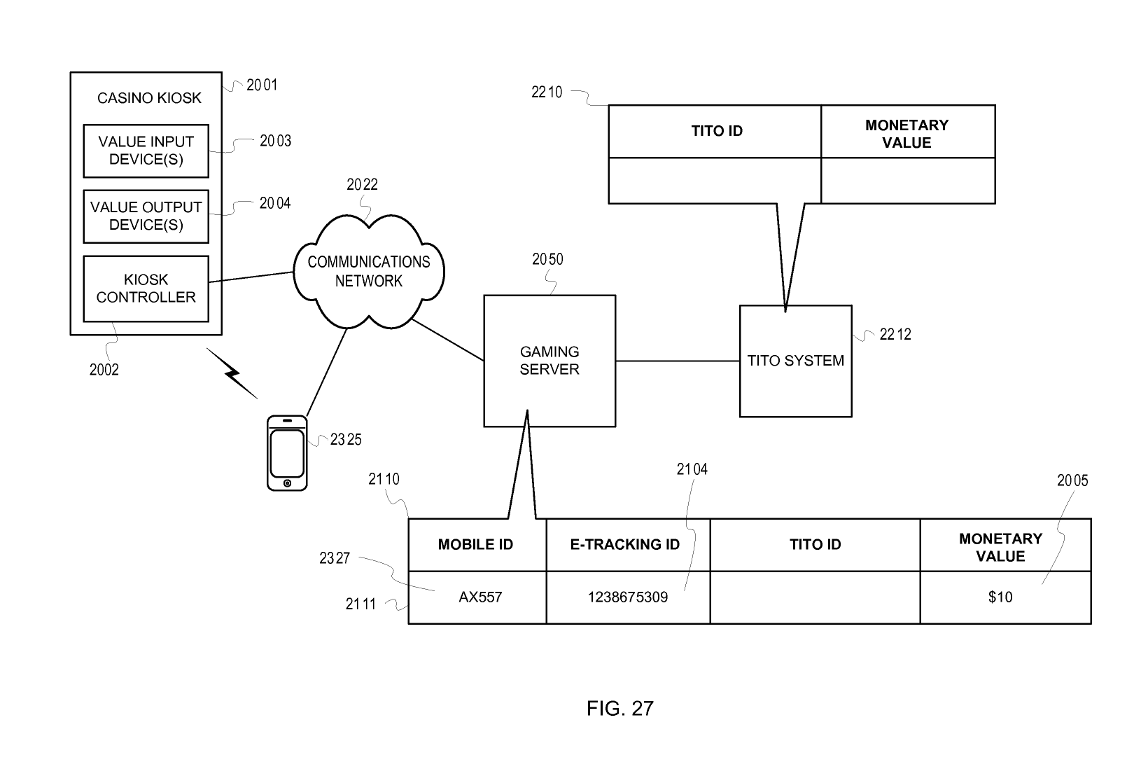

Referring back to FIG. 19, the flow 1900 continues at processing block 1910, where the gaming server obtains a monetary value for the amount of the cash input from the casino accounting system and associates the monetary value with the electronic tracking identifier. As depicted in FIG. 26, after the mobile ID 2327 is associated with the E-tracking ID 2104 in the database 2110, the gaming server 2050 uses the E-tracking ID 2104 to look up the TITO identifier 2214 in the database 2110. The gaming server 2050 then calls into the TITO system 2212 to redeem the monetary value 2005 from the TITO system 2212. For example, the gaming server 2050, using the TITO identifier 2214, can provide a Cash-In SAS command to the TITO system 2212. The TITO system 2212 responds by transmitting to the gaming server 2050 a funds transfer for the monetary value 2005. As depicted in FIG. 27, the gaming server 2050 receives the funds transfer for the monetary value 2005, stores the monetary value 2005 in the database 2110, and associates the monetary value 2005 with the E-tracking ID 2104 as well as with the mobile ID 2327 (e.g., enters the values, or relational links to the values, into the same database record 2111). In some instances, the mobile ID 2327 and the monetary value 2005 are stored in a secure, non-volatile storage area of the gaming server 2050. In some examples, the TITO system 2212 deletes the TITO identifier 2214 and the monetary value 2005 from the database 2210. In a scenario where the TITO system 2212 deletes the TITO identifier 2214 from its database 2210, the gaming server 2050 can also delete the TITO identifier 2214 from the database 2110. In some examples, the TITO system 2212 and the gaming server 2050 can maintain the TITO identifier 2214 and the monetary value 2005 in other storage locations (e.g., in a transaction history log, in a backup record, etc.).

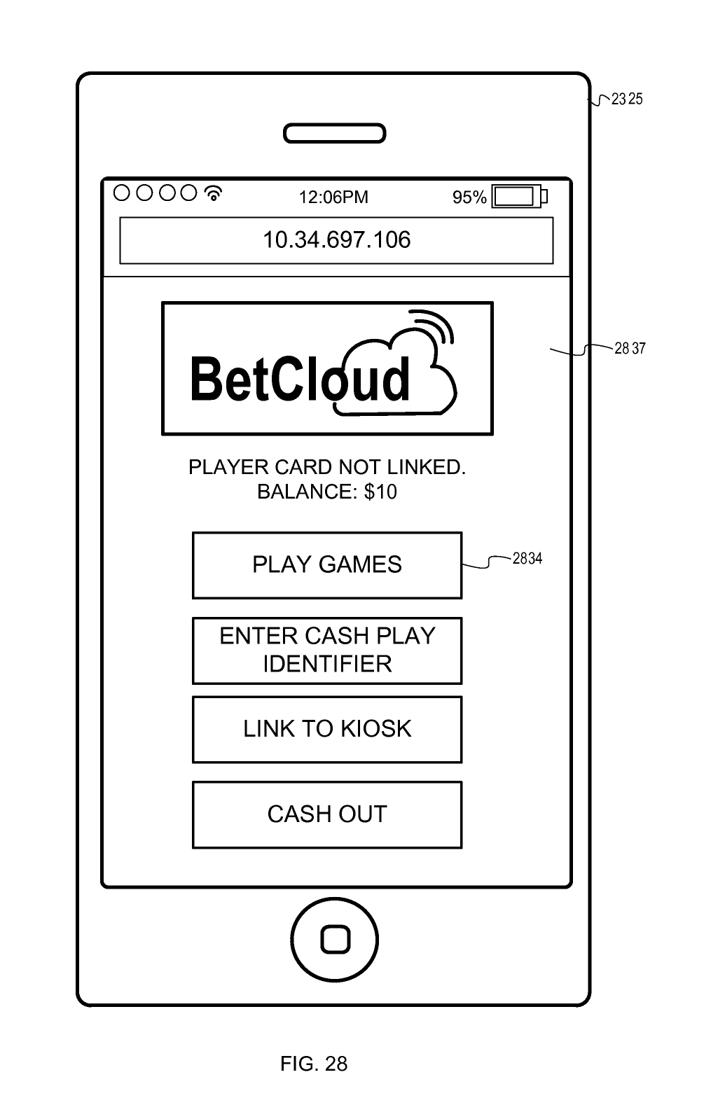

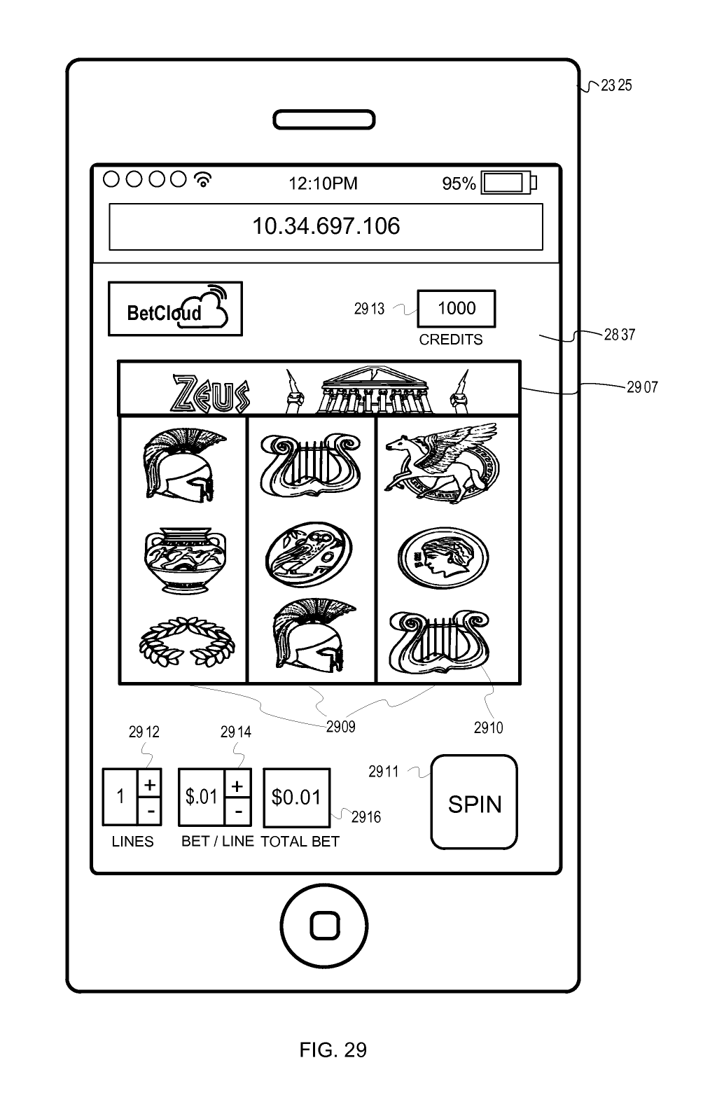

Referring back to FIG. 19, the flow 1900 continues at processing block 1912, where the gaming server modifies the monetary value in response to monetary events associated with the mobile gaming session using the mobile device identifier and electronic tracking identifier. For example, as depicted in FIG. 28, a button 2834 can be selected via a gaming application 2837. The button 2834 signifies to “Play Games” which can provide one or more wagering games via the mobile device 2325. FIG. 29 presents an example of a wagering game 2907 presented on the mobile device 2325. The wagering game 2907 includes wagering game elements (e.g., reels 2909 and symbols 2910) as well as game play controls (e.g., a “spin” button 2911, a payline control 2912, and a bet-per-line control 2914). The wagering game 2907 also includes meters (e.g., a total bet meter 2916 and a credit meter 2913 that indicates the monetary value 2005). For instance, after the monetary value 2005 is associated with the E-tracking ID 2104 via the database 2110 (as previously described in FIG. 27), and after the wagering game 2907 is presented via the mobile device 2325, the gaming server 2050 transmits an indication of the monetary value 2005 to the mobile device 2325 via a secure network connection with the mobile device 2325. The wagering game 2907 presents the monetary value 2005 in the credit meter 2913. For example, the $10 value that was originally input via the kiosk 2001 appears as “1000” credits according to a specific betting denomination for the wagering game 2907 (e.g., for a $0.01 betting denomination, $10 is equivalent to 1000 credits, whereas for a $0.25 betting denomination, $10 could appear as 40 credits, and so forth).

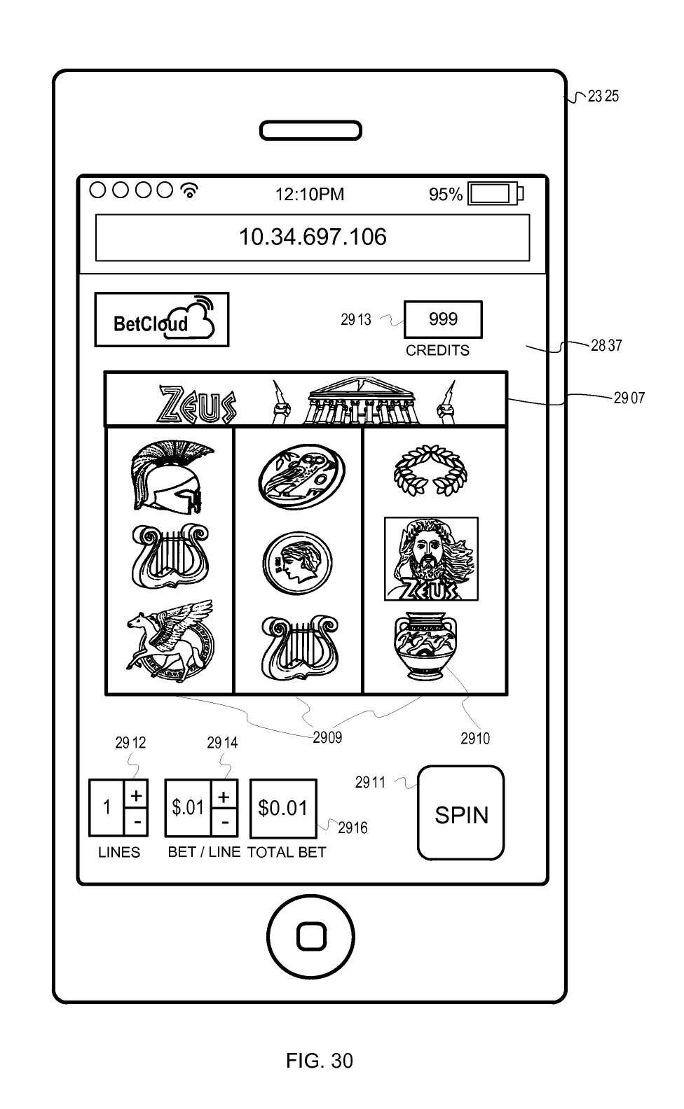

When a bet is made in the wagering game 2907, the gaming server 2050 associates the bet with the mobile ID 2327, and therefore deducts the bet value from the monetary value 2005 within the database 2110. For example, as depicted in FIG. 30, a 1 credit (e.g. $0.01) bet in the wagering game 2907, causes a single playing round to occur, where the reels 2909 spin and a random wagering game outcome is revealed. If no win occurs in the playing round, then the monetary value 2005 reduces from the $10 value to a $9.99 value, and the credit meter 2913 shows a deduction of 1 credit. As more playing rounds occur, and/or as more wagering games are played via the mobile device 2325, the monetary value 2005 changes (e.g., the monetary value 2005 is reduced for bets and increased for winning events).

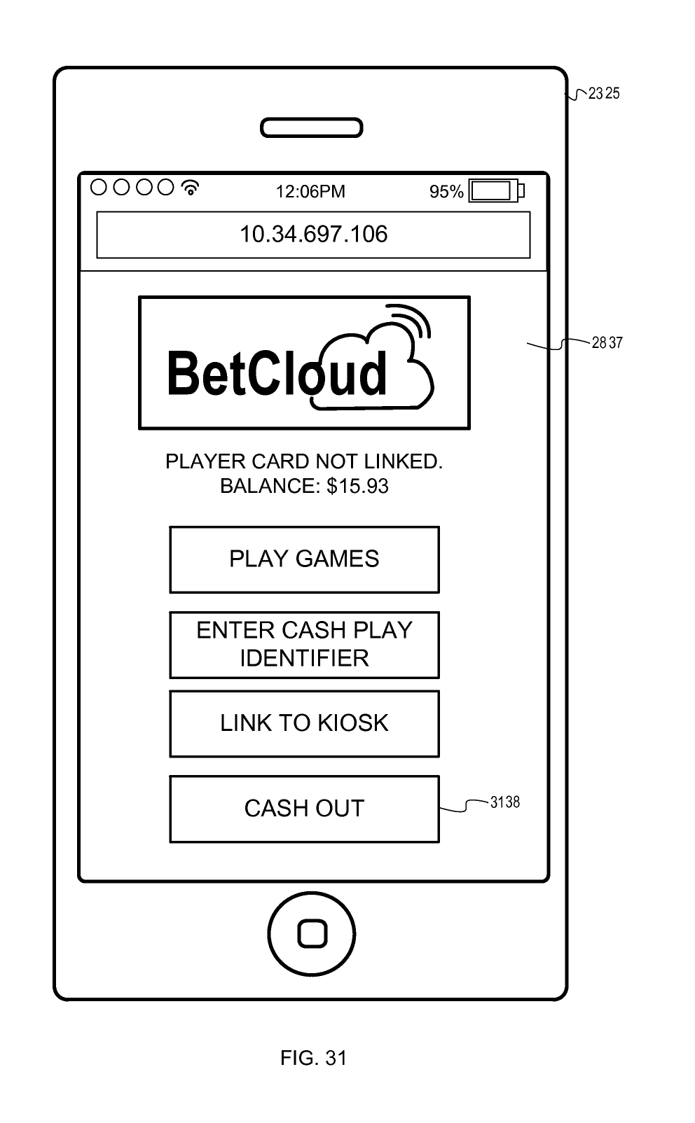

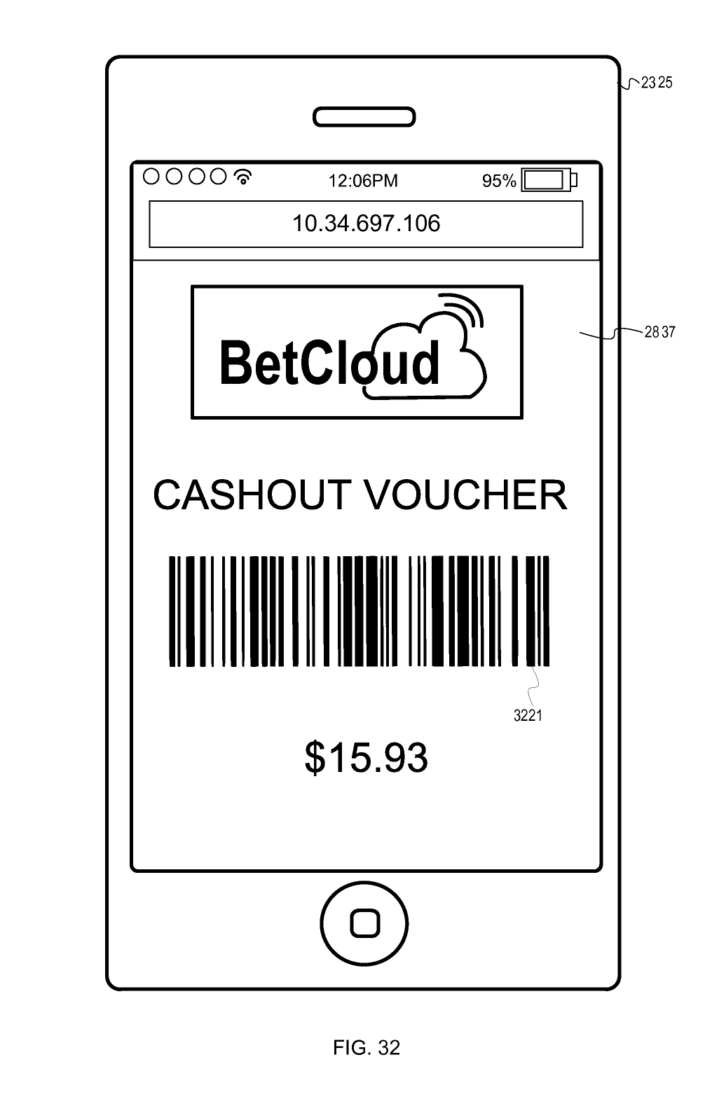

Referring back to FIG. 19, the flow 1900 continues at processing block 1914, where the gaming server cashes out the monetary value for the mobile gaming session. As illustrated in FIG. 31, after the mobile device 2325 has completed with the gaming session, a cash-out procedure is initiated via the mobile device 2325. For example, a player may select a “cash out” button 3138 via the gaming application 2837. As depicted in FIG. 32, the mobile device 2325 may present a cashout voucher with a barcode 3221 which can be scanned at the kiosk 2001. In another example, a cash-out procedure may be initiated when a time-out duration expires. For instance, if the gaming server 2050 does not receive any communications associated with the mobile ID 2327 within a given time period (e.g., a time out period of 15 minutes), then the gaming server 2050 may automatically initiate the cash-out procedure. In another example, the cash-out procedure may be initiated via the kiosk 2001 (e.g., by pressing a “cash out” button at the kiosk 2001, by scanning a code from the mobile device 2325, etc.).

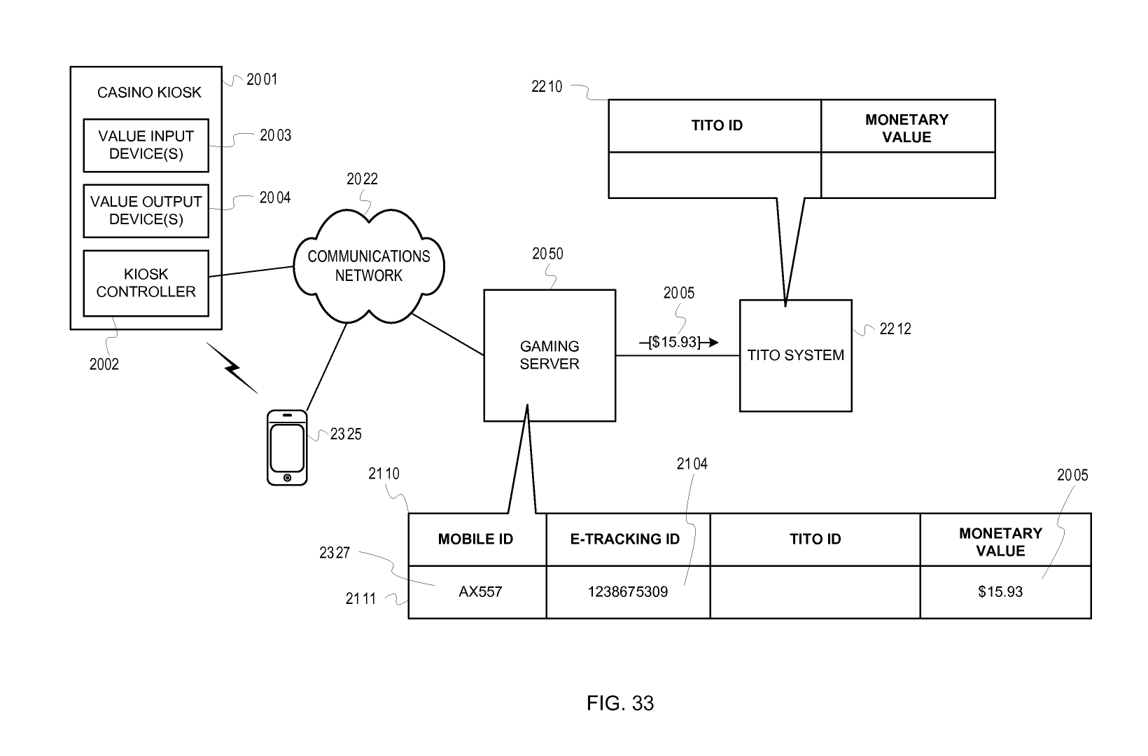

Referring to FIG. 33, after the cash-out procedure is initiated, the gaming server 2050 communicates with the TITO system 2212, such as by transmitting a Cash-Out SAS command using the monetary value 2005 (e.g., the $15.93 value).

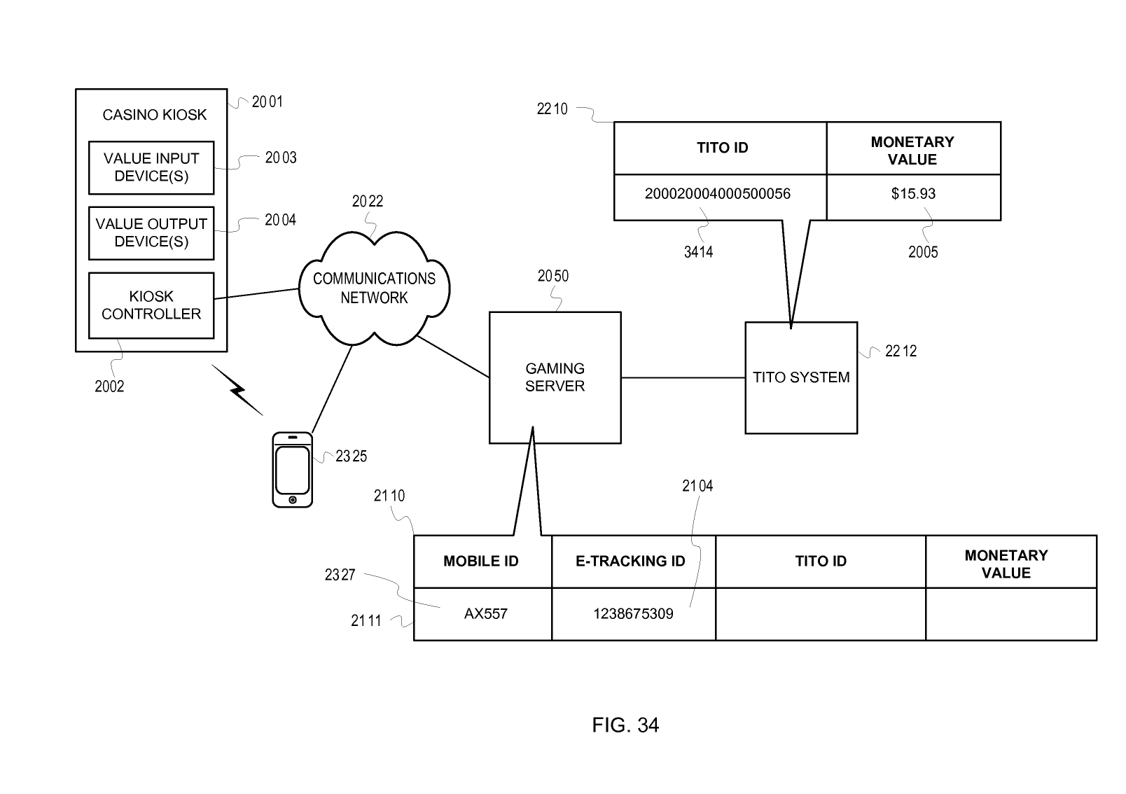

Referring to FIG. 34, TITO system 2212 receives the communication from the gaming server 2050 and generates a new casino accounting system identifier, such as a new 18-digit unique TITO identifier (e.g., “TITO identifier 3414”) and associates the monetary value 2005 with the TITO identifier 3414 in the database 2210. The monetary value 2005 is no longer associated with the database 2110.

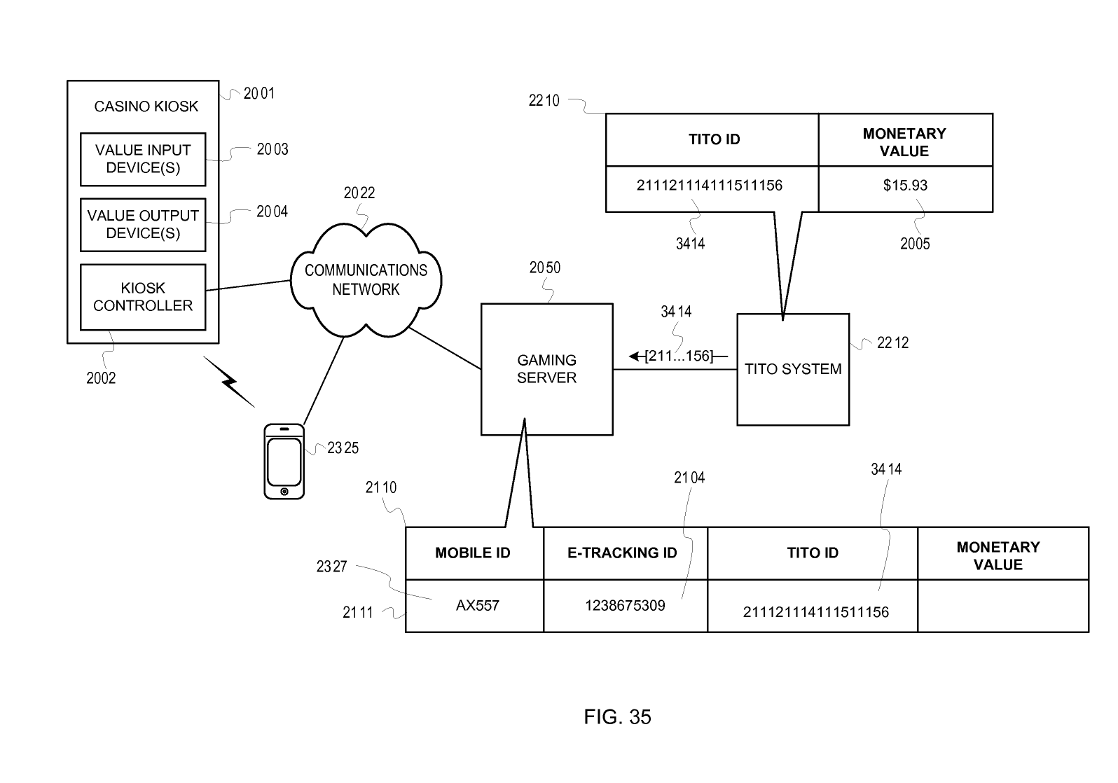

Referring to FIG. 35, the gaming server 2050 associates the TITO identifier 3414 with the database 2110.

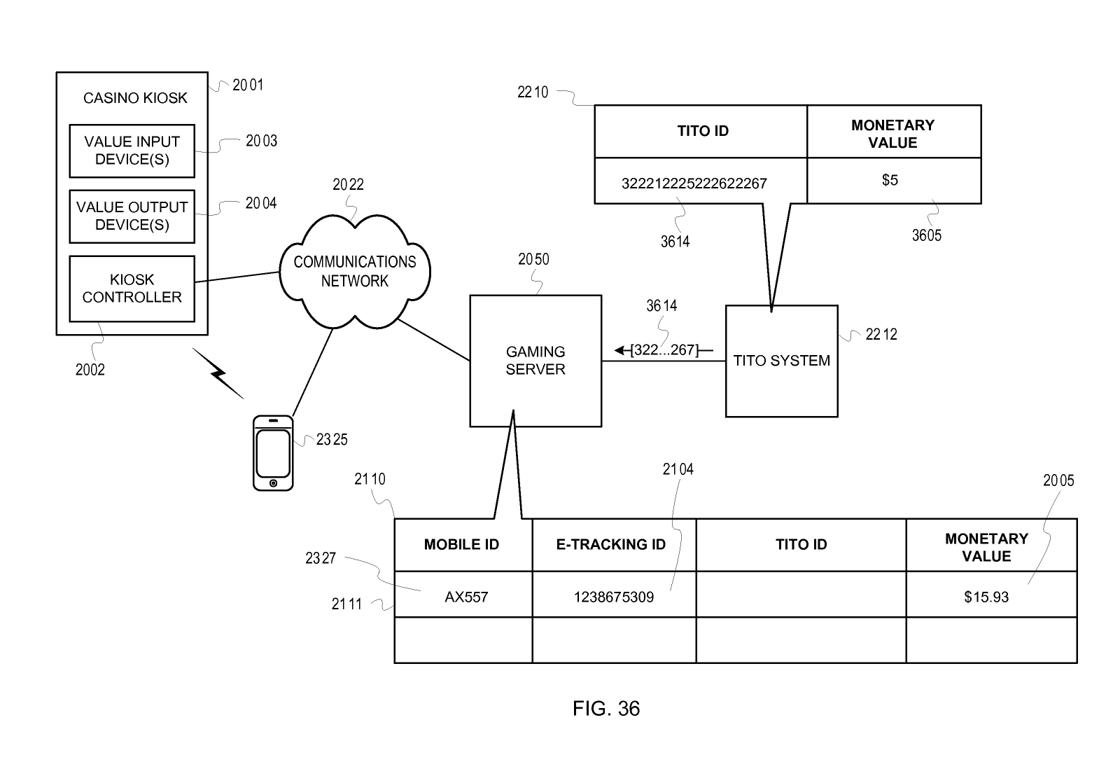

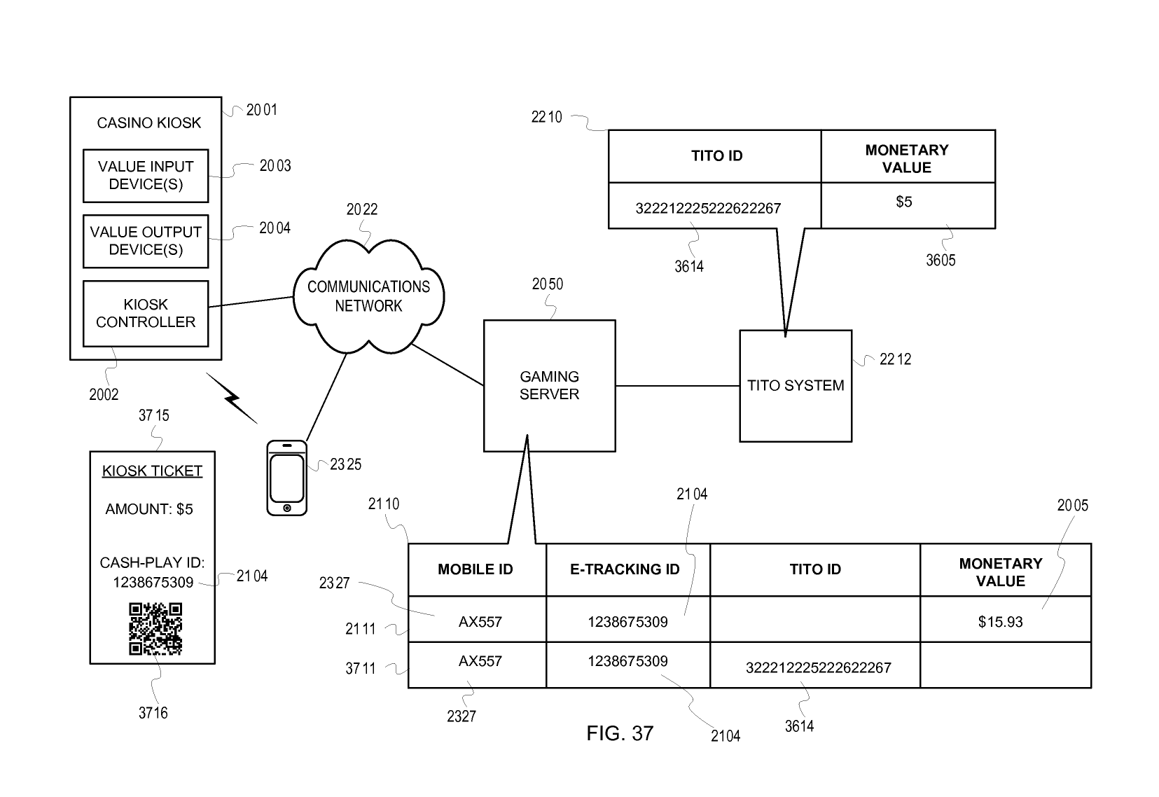

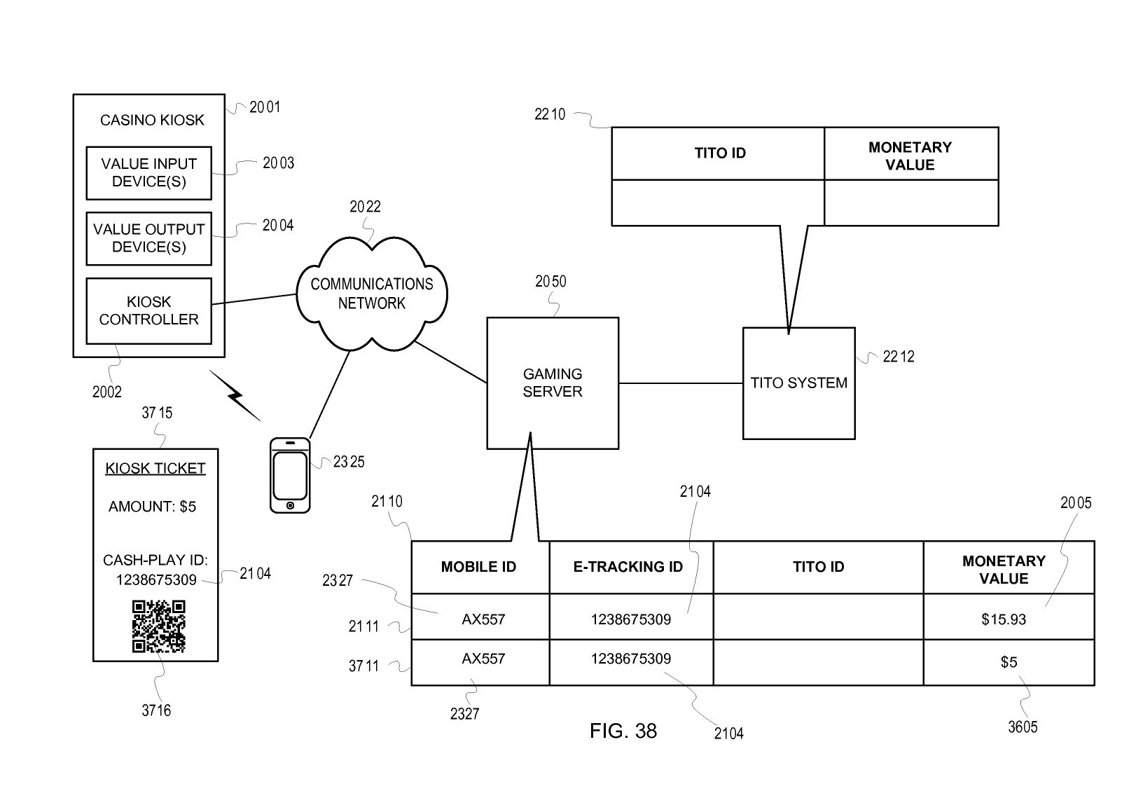

In some instances, additional monetary value may be added via the kiosk using the same E-tracking ID. For instance, during the mobile gaming session, a player may want to add more funds for gambling. The player can utilize the kiosk to add the additional funds. The gaming server subsequently detects the additional funds input as well as an additional monetary value associated with the funds-input at a casino kiosk. However, the gaming server does not need to generate another E-tracking ID. Instead, the gaming server can associate the additional monetary value with the same E-tracking ID that is used for the same mobile gaming session. For instance, supposing at the point shown in FIG. 33, an additional $5 is added to the mobile gaming session via the kiosk 1901 as illustrated in FIG. 36. The gaming server 2050 can provide the additional monetary value 3605 to the TITO system 2212. The TITO system 2212 enters the additional monetary value 3605 into the database 2210 and associates it with a new 18-digit TITO identifier 3614. As shown in FIG. 37, the gaming server 2050 can instruct the kiosk 2010 to print another ticket 3715 with another barcode 3716, which can be scanned at the kiosk 2001 and/or or linked to the mobile device 2325. As shown in FIG. 37, the gaming server 2050 associates the same E-tracking ID 2104 and the same mobile ID 2327 as before with the new TITO identifier 3614 in a second record 3711 of the database 2110. Then, as shown in FIG. 38, the gaming server 2050 determines the additional monetary value 3605 from the TITO system 2212 (e.g., by initiating a Cash-In SAS command). The gaming server 2050 then associates the additional monetary value 3605 with the E-tracking ID 2104 and the mobile ID 2237 in the second record 3711 of the database 2110.

The examples shown in FIGS. 36-38 illustrate only one way in which additional funds can be added to the gaming session. For example, instead of adding a second record 3711 to the database 2110, as was described in FIG. 37, the gaming server 2050 could instead cash out the $15.93 amount (passing the value to the TITO system 2212 via a Cash-Out SAS command), and also provide the additional monetary value 3605 (i.e., the $5 amount) to the TITO system 2212. The gaming server 2050 would keep open the database record 2111. Then, the TITO system 2212 can combine both of the monetary value 2005 and the additional monetary value 3605 into one combined monetary value. The TITO system 2212 can further generate the new TITO identifier 3614, and associate the combined monetary value with the new TITO identifier 3614. Later, the gaming server 2050 can per determine the combined monetary value (e.g., by initiating a Cash-In SAS command), and associate the combined monetary value with the E-tracking ID 2104 in the database record 2111. In some examples, multiple mobile devices can be associated with the same E-tracking ID. For example, multiple players can bet using different mobile device using one or more monetary values associated with the E-tracking ID.

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. Each of the embodiments described herein are contemplated as falling within the inventive subject matter, which is set forth in the following claims.

1. A method of operating a gaming server to conduct a mobile gaming session, said method comprising:
detecting, via a network communication interface of the gaming server, a cash input at a casino kiosk;
generating, via an electronic processing unit of the gaming server, an electronic tracking identifier;
storing a first copy of the electronic tracking identifier in a memory accessible to the gaming server;
causing a casino accounting system to generate a casino accounting system identifier associated with an amount for the cash input, wherein the casino accounting system is independent from the gaming server;
obtaining, from the casino accounting system via the network communication interface, the casino accounting system identifier;
associating the casino accounting system identifier with the first copy of the electronic tracking identifier in the memory; and
instructing the casino kiosk to present a second copy of the electronic tracking identifier to link a mobile device for the mobile gaming session.

2. The method of claim 1 further comprising:
detecting an interaction between the mobile device and the casino kiosk using the second copy of the electronic tracking identifier;
determining a mobile device identifier associated with the mobile device in response to detecting the interaction; and
storing the mobile device identifier in the memory.

3. The method of claim 2 further comprising:
obtaining a monetary value for the amount of the cash input from the casino accounting system;
storing the monetary value in the memory, wherein the monetary value corresponds to the first copy of the electronic tracking identifier; and
using the mobile device identifier during the mobile gaming session to modify the monetary value stored in the memory in response to one or more monetary events of the mobile gaming session.

4. The method of claim 3, wherein the using the mobile device identifier during the mobile gaming session to modify the monetary value stored in the memory in response to the one or more monetary events of the mobile gaming session comprises:
detecting, via the network communication interface, for each event from the one or more monetary events, a third copy of the electronic tracking identifier transmitted from the mobile device;
detecting, via the network communication interface, for each event a monetary event value;
determining that the third copy of the electronic tracking identifier corresponds to the first copy of the electronic tracking identifier stored in the memory;
accessing the monetary value stored in the memory; and
computing the monetary event value with the monetary value.

5. The method of claim 4, wherein the event is a bet in a wagering game presented via the mobile device, wherein the monetary event value is an amount of the bet, and wherein the computing the monetary event value with the monetary value comprises subtracting the amount of the bet from the monetary value.

6. The method of claim 4, wherein the event is an award for a wagering game outcome in a wagering game presented via the mobile device, wherein the monetary event value is an amount of the award, and wherein the computing the monetary event value with the monetary value comprises adding the amount of the award to the monetary value.

7. The method of claim 4, wherein the event is one or more of a cash deposit or a cash withdrawal associated with one or more of the mobile device or the casino kiosk, wherein the monetary event value is an amount of the one or more of the cash deposit or the cash withdrawal, and wherein the computing the monetary event value with the monetary value comprises:
if the event is the cash deposit, adding the amount of the cash deposit to the monetary value; and
if the event is the cash withdrawal, subtracting the amount of the cash withdrawal from the monetary value.

8. The method of claim 3, wherein the obtaining the monetary value for the amount of the cash input from the casino accounting system comprises:
initiating a cash-out procedure with the casino accounting system in the amount of the cash input, wherein the casino accounting system generates the casino accounting system identifier for the cash input and stores the monetary value for the amount of the cash input in a data store of the casino accounting system associated with the casino accounting system identifier;
receiving the casino accounting system identifier from the casino accounting system in response to initiating the cash-out procedure;
associating the casino accounting system identifier with the first copy of the electronic tracking identifier in the memory;
initiating a cash-in procedure with the casino accounting system to obtain the monetary value;
receiving, from the casino accounting system, the monetary value; and
associating the monetary value with the first copy of the electronic tracking identifier in the memory.

9. The method of claim 1, wherein the gaming server is configured to communicate with the casino accounting system via a Slot Accounting System (SAS) communication protocol.

10. The method of claim 1, wherein the casino accounting system comprises a Ticket-In Ticket-Out (TITO) system.

11. A non-transitory, machine-readable storage medium having instructions stored thereon, which cause one or more electronic processing units of a gaming server to perform operations for conducting a mobile gaming session, said operations comprising:
detecting, via a network communication interface of the gaming server, an amount of a cash input at a casino kiosk;
generating, via an electronic processing unit of the gaming server, an electronic tracking identifier;
storing the electronic tracking identifier in a memory accessible to the gaming server;
storing a monetary value in the memory, wherein the monetary value indicates at least the amount of the cash input;
determining a mobile device identifier associated with a mobile device; and
using the mobile device identifier and the electronic tracking identifier during the mobile gaming session to modify the monetary value stored in the memory in response to one or more monetary events of the mobile gaming session.

12. The non-transitory, machine-readable storage medium of claim 11, said operations further comprising:
vending, via the network communication interface, the amount of the cash input with a casino accounting system independent from the gaming server; and
wherein the storing the monetary value in the memory comprises storing the monetary value in the memory in response to vending the amount of the cash input with the casino accounting system.

13. The non-transitory, machine-readable storage medium of claim 12, wherein the operations for vending the amount of the cash input with the casino accounting system includes operations comprising:
initiating a cash-out procedure with the casino accounting system in the amount of the cash input, wherein the casino accounting system generates a casino accounting system identifier for the cash input and stores the monetary value for the amount of the cash input in a data store of the casino accounting system associated with the casino accounting system identifier;
receiving the casino accounting system identifier from the casino accounting system in response to initiating the cash-out procedure;
associating the casino accounting system identifier with the electronic tracking identifier in the memory;
initiating a cash-in procedure with the casino accounting system to obtain the monetary value;
receiving, from the casino accounting system, the monetary value;
associating the monetary value with the electronic tracking identifier in the memory.

14. The non-transitory, machine-readable storage medium of claim 12, wherein the gaming server is configured to communicate with the casino accounting system via a Slot Accounting System (SAS) communication protocol.

15. The non-transitory, machine-readable storage medium of claim 12, wherein the casino accounting system comprises a Ticket-In Ticket-Out (TITO) system.

16. The non-transitory, machine-readable storage medium of claim 11, wherein the operations for using the mobile device identifier and the electronic tracking identifier during the mobile gaming session to modify the monetary value stored in the memory includes operations comprising:
storing an instance of the mobile device identifier in the memory;
detecting a wager made via the mobile device;
receiving an indication of the mobile device identifier from the mobile device in association with the wager;
evaluating the indication of the mobile device identifier with the instance of the mobile device identifier stored in the memory;
determining, from the memory, an amount of the monetary value; and
deducting an amount of the wager from the amount of the monetary value.

17. The non-transitory, machine-readable storage medium of claim 11, wherein the one or more monetary events comprise one or more of placing a wager on a wagering game presented in the mobile gaming session, rewarding a wagering game win that occurs in the mobile gaming session, receiving additional cash input for the mobile gaming session, and withdrawing cash from the mobile gaming session.

18. A gaming server comprising:
one or more electronic processing units;
a network communication interface; and
a memory storage device configured to store instructions, which when executed by at least one of the one or more electronic processing units, cause the gaming server to perform operations to,
detect, via the network communication interface, a cash input at a casino kiosk,
generate an electronic tracking identifier;
store a first copy of the electronic tracking identifier in a memory accessible to the gaming server,
cause a casino accounting system to generate at least one casino accounting system identifier associated with an amount for the cash input, wherein the casino accounting system is independent from the gaming server,
obtain, from the casino accounting system via the network communication interface, the at least one casino accounting system identifier,
associate the at least one casino accounting system identifier with the first copy of the electronic tracking identifier in the memory; and
instruct the casino kiosk to present a second copy of the electronic tracking identifier to link a mobile device for the mobile gaming session.

19. The gaming server of claim 18, wherein the memory storage device is configured to store instructions, which when executed by at least one of the one or more electronic processing units, cause the gaming server to perform operations to:
detect an interaction between the mobile device and the casino kiosk using the second copy of the electronic tracking identifier;
determine a mobile device identifier associated with the mobile device in response to detecting the interaction; and
store the mobile device identifier in the memory.

20. The gaming server of claim 19, wherein the memory storage device is configured to store instructions, which when executed by at least one of the one or more electronic processing units, cause the gaming server to perform operations to:
obtain a monetary value for the amount of the cash input from the casino accounting system;
store the monetary value in the memory, wherein the monetary value corresponds to the first copy of the electronic tracking identifier; and
use the mobile device identifier during the mobile gaming session to modify the monetary value stored in the memory in response to one or more monetary events of the mobile gaming session.

21. The gaming server of claim 20, wherein the memory storage device is configured to store instructions, which when executed by at least one of the one or more electronic processing units, cause the gaming server to perform operations to:
detect, via the network communication interface, for each event from the one or more monetary events, a third copy of the electronic tracking identifier transmitted from the mobile device;
detect, via the network communication interface, for each event a monetary event value;
determine that the third copy of the electronic tracking identifier corresponds to the first copy of the electronic tracking identifier stored in the memory;
access the monetary value stored in the memory; and
compute the monetary event value with the monetary value.
